(19) United States
(12) Patent Application Publication
(10) Pub. No.: US 2005/0171833 A1
(43) Pub. Date: Aug. 4, 2005

(54) Systems and methods for acquiring time-dependent data for business process analysis

(76) Inventors: Wolfram Jost, Schmelz (DE); Helge Hess, Riegelsberg (DE); Tobias Blickle, Saarbruecken (DE); Markus von den Driesch, Puettlingen (DE)

Correspondence Address: FINNEGAN, HENDERSON, FARABOW,;GARRETT & DUNNER, L.L.P., 1300 I Street, N.W., Washington, DC, 20005, US

(21) Appl. No.: 10/975,069

(22) Filed: Oct. 28, 2004

Related U.S. Application Data
(60) Provisional application No. 60/514,613, filed on Oct. 28, 2003.

(51) Int. Cl. G06F 17/60

(52) U.S. Cl. 705/10

(57) ABSTRACT

Computerized methods and systems are provided for acquiring time-dependent data for business process analysis. In such methods and systems, information may be imported from a plurality of source systems using a generic interface. Further, process fragments may defined from the imported information and the process fragments may be merged to generate process instances. The process instances may then be merged to generate a process model, which may represent a business process. Further, configurable performance indicators may be calculated in order to analyze a business process. The performance indicators may be calculated based on the process model and information imported from the plurality of source systems. As a result, users may investigate specific processes and indicators in detail, as well as overall business process performance on an aggregated basis.

### CROSS REFERENCE TO RELATED APPLICATION(S)

This application claims the benefit of priority to U.S. Provisional Patent Application No. 60/514,613 entitled, “Systems and Methods for Acquiring Time-Dependent Data for Business Process Analysis,” filed Oct. 28, 2003, the disclosure of which is expressly incorporated herein by reference to its entirety.

### TECHNICAL FIELD

The present invention generally relates to data processing. More particularly, the invention relates to systems and methods for acquiring time-dependent runtime data for business process analysis.

### BACKGROUND

Business processes are at the core of many enterprises. Business processes typically describe a coordinated series of functions and/or activities that aim to produce added value. Business processes often seek to meet customer value requirements. Often, the success of an organization is tied to the success of its business processes. To achieve increased levels of success and value, therefore, organizations may need to improve their primary business processes. Improving business processes often requires business process analysis, which may involve continually measuring, evaluating, and optimizing business process performance. Analyzing business process performance can assist a company in identifying sources of revenue loss and in optimizing resource deployment.

In certain instances, analyzing business processes may include investigating process performance based on data from systems implementing the process. Because business processes typically span various IT applications, data from different operational systems can be leveraged to measure system performance. Measuring system performance, however, often requires a procedure for acquiring runtime data. Further, continual and robust process analysis may require a closed loop of business process management, which may include the design, implementation, and execution of business processes, as well as measuring, analyzing, and optimizing its performance.

Conventional approaches to acquiring data from systems implementing a business process often rely on Extraction, Transformation and Loading (ETL) technology implemented in so-called adapters. These adapters are specific adapters that are implemented for each system. With such an approach, however, proprietary systems (legacy systems) can only be connected via individually developed adapters. Further, specific adapters are limited in the ability to import business processes into repositories used by their respective business process analysis system. Specific adapters are usually capable of importing only generated processes. Moreover, conventional approaches are limited by constraints on evaluating process performance using indicators. For example, available indicators are often fixed and changes can only be realized by altering the configuration.

### SUMMARY

Methods, systems, and articles of manufacture consistent with aspects and principles of the present invention may obviate one or more of the above and/or other issues. Embodiments of the present invention are directed to methods and systems that improve data acquisition for business process analysis. Embodiments of the invention are also directed to methods and systems for performing business process analysis. In certain implementations of the invention, methods and systems may acquire data for business process analysis and perform efficient business process analysis, including process performance management.

Methods and systems consistent with the present invention may acquire information to perform business process analysis. Methods and systems may import time-dependent data from a plurality of source systems using a generic import interface. The source systems may include applications and systems implementing one or more business processes. Methods and systems may define process fragments from the imported time-dependent data and merge the process fragments to generate process instances. The process instances may then be merged to generate a process model, which may represent a business process.

Further, methods and systems may calculate configurable performance indicators in order to analyze a business process. The performance indicators may be calculated based on a process model and time-dependent data imported from the plurality of source systems. For example, the indicators may be calculated for each instance of a business process.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 illustrates an overview of features and aspects consistent with embodiments of the present invention;

FIG. 2 is a flowchart of an exemplary method consistent with embodiments of the present invention;

FIG. 3 is a flowchart depicting an exemplary method for reconstructing a business process consistent with the present invention;

FIG. 4 illustrates an exemplary process fragment consistent with embodiments of the present invention;

FIG. 5 illustrates exemplary aspects of defining process fragments consistent with embodiments of the invention;

FIGS. 6A and 6B illustrate aspects of merging process fragments consistent with embodiments of the present invention;

FIG. 7 depicts aspects of merging process instances into process models consistent with embodiments of the present invention;

FIG. 8 depicts aspects of providing results to target groups consistent with embodiments of the present invention;

FIG. 9 depicts aspects of obtaining information, reconstructing business processes, and analyzing business processes consistent with embodiments of the present invention;

FIG. 10 is a block diagram of an exemplary business process management system consistent with embodiments of the present invention;

FIG. 11A depicts aspects of an exemplary log file consistent with embodiments of the present invention;

FIG. 11B depicts additional, exemplary excerpts of a log file and an exemplary DTD file, consistent with embodiments of the present invention;

FIGS. 12A and 12B illustrate exemplary aspects of and excerpts from XML fragment definition files consistent with embodiments of the present invention;

FIG. 12C illustrates an exemplary DTD file for specifying the structure for XML files consistent with embodiments of the invention;

FIG. 12D illustrates exemplary excerpts from an XML mapping definition file and a corresponding DTD file consistent with embodiments of the invention;

FIG. 12E illustrates excerpts from another exemplary log file consistent with embodiments of the present invention;

FIG. 12F illustrates an exemplary listing of generated process fragments consistent with embodiments of the present invention;

FIG. 12G illustrates exemplary excerpts of merge key and process key settings and rule selections consistent with embodiments of the present invention;

FIG. 13A illustrates exemplary performance indicators and dimensions consistent with embodiments of the present invention;

FIG. 13B illustrates an exemplary performance indicator formula consistent with embodiments of the present invention;

FIG. 13C illustrates an exemplary info cube consistent with embodiments of the invention;

FIGS. 14A-14C respectively illustrate exemplary screen shots consistent with embodiments of the present invention;

FIG. 15 is a block diagram of an exemplary environment compatible with features and aspects of the present invention;

FIG. 16 illustrates one exemplary configuration of a client-server architecture consistent with embodiments of the present invention; and

FIG. 17 is a flowchart depicting an exemplary business process analysis method consistent with embodiments of the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention. Other implementations may be used and structural and procedural changes may be made without departing from the scope of present invention.

Conceptual Overview

Consistent with aspects of the present invention, methods and systems may acquire time dependent data for business process analysis. Embodiments of the invention may provide methods and systems for performing business process analysis, including process performance management. Methods and systems consistent with the invention may obtain time-dependent runtime data from a plurality of systems associated with a business process (e.g., IT systems, customer systems, etc.). In one implementation of the present invention, a generic import interface may obtain the runtime data. Methods and systems may reconstruct, measure, and analyze a plurality of business processes using the generic import interface.

In certain embodiments of the invention, methods and systems may generate business process representations using runtime information obtained from source systems. In one embodiment, process instances may be generated using obtained runtime data. Methods and systems may merge and consolidate data records received from various sources to generate instances of a business process. The instances may be further merged to generate a business process model, which may represent the business process.

Business process performance may be measured using the data and/or the representations for any process or purpose including, for example, process performance management. In at least one example, arbitrarily configurable performance indicators may be calculated (e.g., for each instance of a business process) to measure and analyze business process performance. The indicators may be calculated subject to one or more predefined filters and/or differentiators. Process instances can be displayed and analyzed as discrete process instances or on an aggregated level.

Consistent with embodiments of the present invention, methods and systems may provide a full insight into the operational activities across organizations and applications within one or more enterprises. Embodiments of the invention can allow a user to visualize every single business process model or any number of them on an aggregated level. Methods and systems may maintain information obtained from source systems, business process models, and performance analysis data. Such methods and systems may provide one or more knowledge bases or repositories, from which users can access business process analysis information.

Methods and systems may allow users to view and analyze business process models and process performance, as well as initiate analyses, configure parameters, and store and retrieve information. Consistent with the present invention, users may choose between various analysis views in order to gain an overview of process performance and/or analyze processes and indicators in detail.

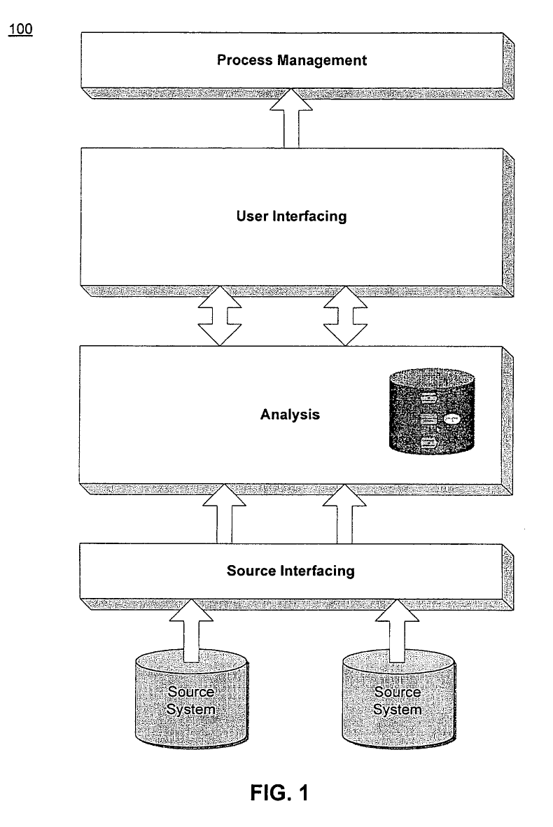

FIG. 1 illustrates an overview 100 that graphically depicts certain aspects of the present invention. As illustrated, methods and systems consistent with embodiments of the invention may provide source-interfacing functionality for obtaining information from one or more source systems implementing business processes. Methods and systems consistent with the invention may analyze business processes based on the obtained information. Embodiments of the present invention may also provide user-interfacing functionality, which may facilitate process management and strategic decision making.

The foregoing discussion is intended to introduce and provide initial clarity for some of the aspects associated with the present invention. Further details of the above-mentioned functionality and embodiments as well as additional aspects, features, and embodiments of the present invention will be described below.

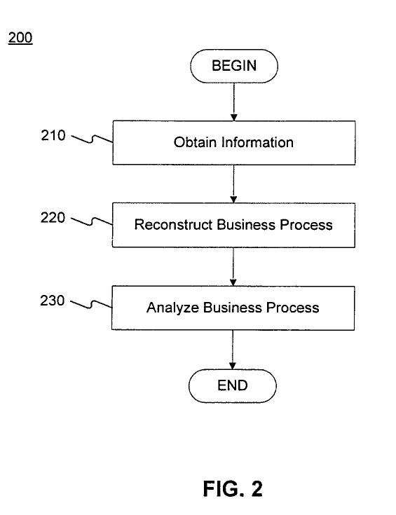

FIG. 2 illustrates an exemplary flowchart 200 consistent with embodiments of the present invention. As illustrated in FIG. 2, methods and systems may obtain information (step 210) from business process source systems, reconstruct business processes (stage 220) from that information, and analyze business processes (stage 230).

Obtaining Information

Consistent with embodiments of the present invention, information may be obtained (step 210) from a one or more source systems associated with a business process. As used herein, the term “business process” refers to any related group of activities that produce an output associated with a value-related goal. A business process “activity” may include any operation, procedure, task, process step, transaction, initiative, and/or sequence of actions performed in order to achieve the overall business process goal. Business process activities may be computer-performed and/or performed by one or more individuals (e.g., executives, workforce, customers, etc.). Business processes may be associated with one or more business entities, which may include organizations, corporations, partnerships, firms, enterprises, service providers, manufacturers, suppliers, distributors, wholesalers, retailers, educational institutions, government agencies, etc. A business process may be developed within a single business entity and implemented either within a single business entity or across several business entities. In addition, business processes could be collaboratively developed among several business entities.

The term “source system” refers to any system or element that implements (e.g., executes an activity) and/or impacts a business process. Source systems may include any resource or basis from which information related to a business process may be obtained. Obtaining information from source systems may comprise obtaining information from one or more elements included in or coupled to IT infrastructures, information systems, logistics systems, financial infrastructures and accounting systems, procurement systems, operations systems, human resource systems, customer interface systems, storage networks and infrastructures, etc. Obtaining information from source systems may include acquiring information from workflow software, CRM (customer relationship management) systems, ERP (enterprise resource management) systems, EAI (enterprise application integration) tools, CIM (Computer Integrated Manufacturing) tools, SCM (Supply Chain Management) systems, customer-, supplier-, and/or internal-oriented e-Business applications, and any other business-related applications and/or intelligence. Source systems might, in certain embodiments, encompass elements associated with individuals, organizations, markets, and regulations.

Consistent with principles and aspects of the present invention, obtaining information from source systems may include importing data acquired from a plurality of source systems. In one embodiment, obtaining data from source systems may involve identifying those source systems related to a particular business process and establishing an underlying infrastructure for extracting information from one or more source systems. Obtaining information may also include monitoring a plurality of source systems (either continually or at predetermined intervals) and extracting and/or receiving information from those systems.

Obtaining information from source systems may include importing, receiving, and/or extracting any information associated with those source systems. Information obtained from source systems may include any information (e.g., data records) related to the performance of a particular business process. Obtaining information from source systems may include obtaining transaction sequences, document flows, executed instructions and/or actions, source system statutes, machine state values, activity logs, billing data, sales data, supply data, revenue data, marketing data, statistical data, etc. Obtaining information may include importing time-dependent data from source systems, such as real-time data and/or runtime data. In certain embodiments of the invention, information obtained from source systems may include numerical data (e.g., floating point numbers), binary information, character strings, symbolic elements, electromagnetic signals, etc. Information obtained from a given source system may represent business process activities performed by that source system. The information may also include data reflecting a status of a business process and/or results of a particular business process activity.

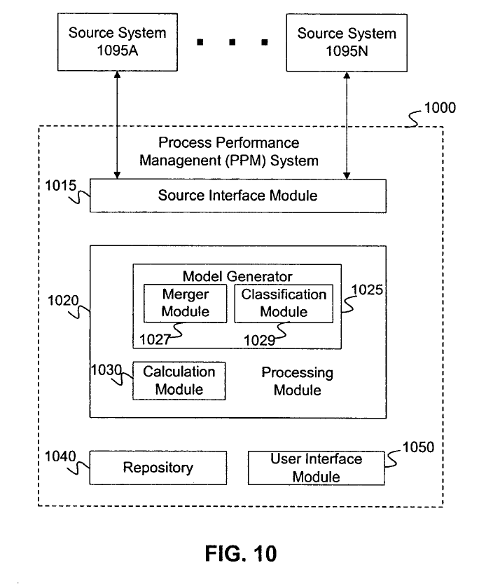

Consistent with certain embodiments, obtaining data from source systems may include providing an import interface to facilitate data acquisition from one or more source systems. Providing an import interface may, in certain embodiments of the invention, include providing a generic interface operable to interact with a plurality of distinctive source systems. An exemplary import interface is detailed below in connection with FIG. 10. In addition, or as an alternative, to a generic import interface, providing an interface may include providing one or more adapters to interact with specific source systems in order to facilitate data acquisition. Providing adapters may include defining logic that indicates how to acquire data from specific and distinct source systems.

Obtaining information from source systems may include acquiring information from source systems in more than one format. Providing an interface may, therefore, include facilitating data acquisition from source systems in a plurality of formats. In certain embodiments of the invention, providing an interface may comprise facilitating the acquisition of unstructured or “event-formatted” data. Event-formatted data may include or represent source system events, without information making up the process (i.e., procedural logic). As used herein, the term “source system event” refers to an action performed by a source system and/or a source system status change corresponding to or resulting from one or more executed business process activities. For example, a source system event may include the creation of an order or invoice. Providing an interface may additionally comprise facilitating the acquisition of structured or “graph-formatted” data. Information provided in a graph format may include data representing source system events along with the associated procedural logic. Graph-formatted information may represent one or more process fragments and/or instances of a business process, whereas event-formatted information may represent source system events (e.g., changes in a source system status as a result of an executed business process activity). For example, information obtained from a source system in the event format may include data indicating that an invoice has been created as a result of an executed business process activity, whereas information obtained in the graph format may include information indicating that the invoice has been created along with a triggering occurrence (e.g., order should be created) and the executed business process activity (e.g., create order).

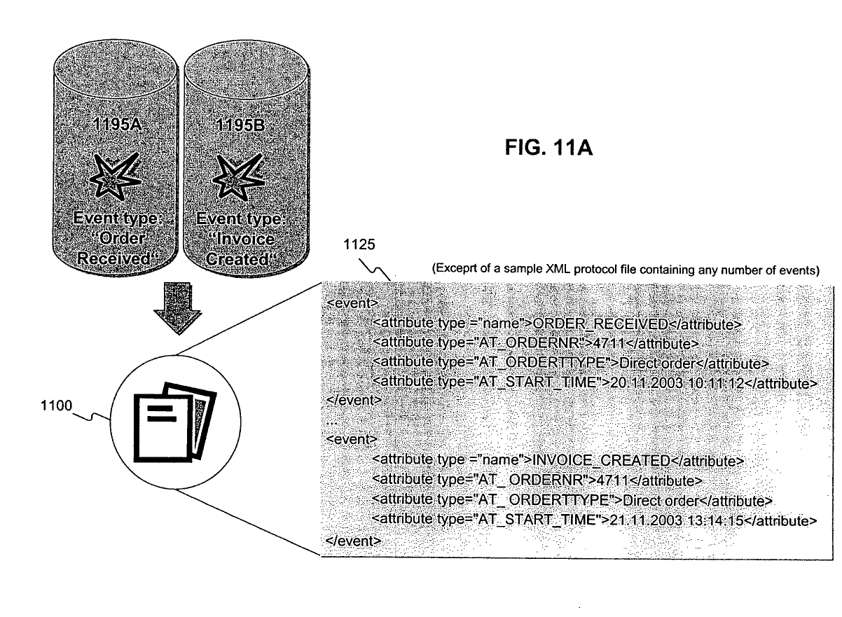

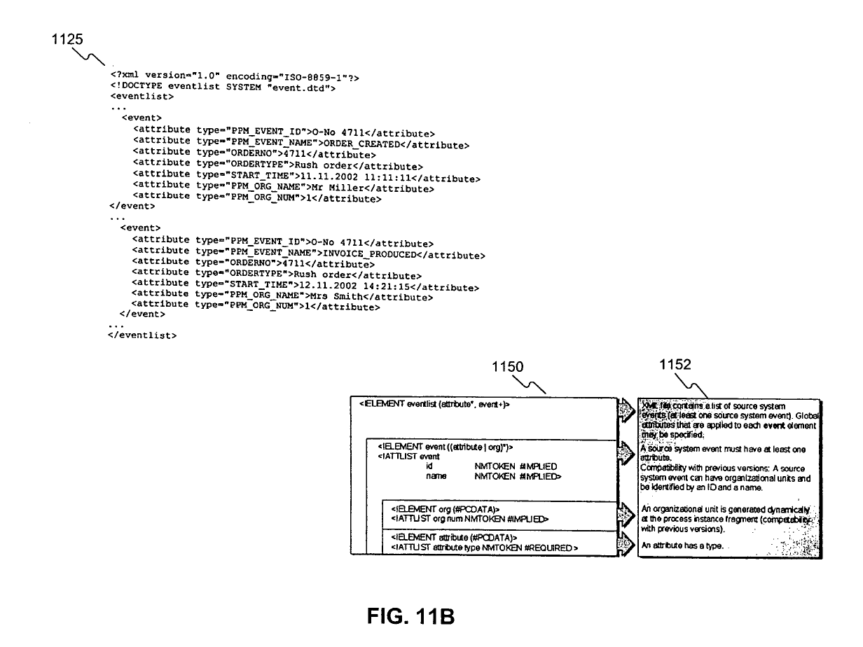

Each business process source system may be operable to provide information in the form of time-stamped data corresponding to business process activities. Obtaining information from source systems may, therefore, include extracting a single data record as a representation of each business process activity (following a chronological order indicated by the time-stamps) and generating a log (e.g., a protocol file) containing information related to the performance of activities by one or more source systems (i.e., source system events). Further details of a protocol file are discussed below in connection with, for example, FIG. 11A. Generating a log may include identifying and naming potential source system events (e.g., system status changes) and then logging occurrences of such events, along with associated information (e.g., attributes with real data). A log may contain actual information about the actual course of a business process and may include different types of events for different system activities. Associated information might include, for example, processing time, processor, and base values for performance indicator calculation and dimensions (the details of which are discussed below).

In certain embodiments of the invention, methods and systems may establish a knowledge base or warehouse, in which information obtained from source systems can be stored. As used herein, the term “knowledge base” refers to any repository, resource, facility, or lexicon, operable to maintain and access information. In one example, establishing a knowledge base may include establishing one or more structured data archives distributed among one or more network-based data processing systems. Details of an exemplary knowledge base consistent with embodiments of the present invention are discussed below in connection with FIG. 10.

Reconstructing Business Processes

Consistent with embodiments of the present invention, one or more business processes may be reconstructed (step 220) based on information obtained from source systems. Reconstructing a business process may include interpreting information received from source systems and generating a representation or model of the business process based on one or more specific business process activities. In one example, reconstructing a business process may involve generating a representation of a business process based on run-time data received from source systems. In one example, reconstructing a business process may include automatically reconstructing a representation of run-time data obtained from source systems based on time stamps of single business process activities. In accordance with aspects and principles of the present invention, process representations may be stored in an established repository or knowledge base.

In accordance with principles and aspects of the present invention, one or more conventions for describing and modeling business processes may be established and/or leveraged in order to facilitate business process reconstruction. A convention may include rules, methods, standards, definitions, and/or protocols for describing and modeling business process workflows. One exemplary business process modeling convention that may be utilized is the Event-Driven Process Chain (EPC) industry standard. An established business process modeling convention may comprise one or more predefined objects that correspond to data elements representing aspects of business process performance. For example, the EPC standard may utilize function object types, element object types, and connector object types to describe a business process workflow. Functions may correspond to and describe executed business process activities. Events are business process statuses and may describe a process status triggering a function and the result of executing a function. Events may represent actions performed by one more source systems that trigger, and result from, a function. Connectors may serve to associate business process activities with events.

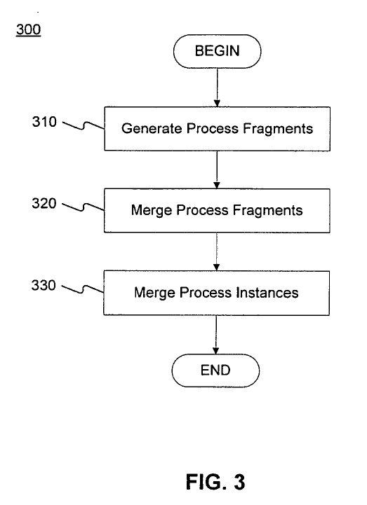

FIG. 3 depicts an exemplary method for reconstructing a business process consistent with embodiments of the present invention. As illustrated, reconstructing a business process may involve generating process fragments (step 310). As used herein, the term “process fragment” refers to a portion of a given business process. A process fragment may represent a particular business process activity and may correspond to one or more actions performed by one or more source systems to perform that business process activity (i.e., source system events). In embodiments leveraging the EPC standard, a “process fragment” may comprise one or more functions (i.e., business process activities) with associated triggering and resulting events (i.e., source system status changes). A process fragment may also contain information about the processor of a function in the form of organizational units.

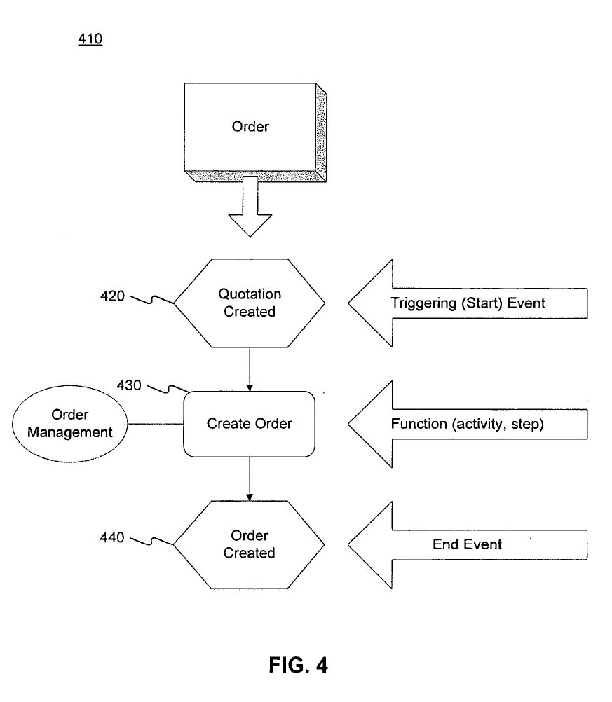

FIG. 4 illustrates an exemplary process fragment 410. Process fragment 410 comprises a “create order” function 430 (i.e., a business process activity), preceded by a “quotation created” event 420 (i.e., the triggering event) and followed by an “order created” event 440 (i.e., the resulting event). Process fragment 410 describes one part of an overall business process.

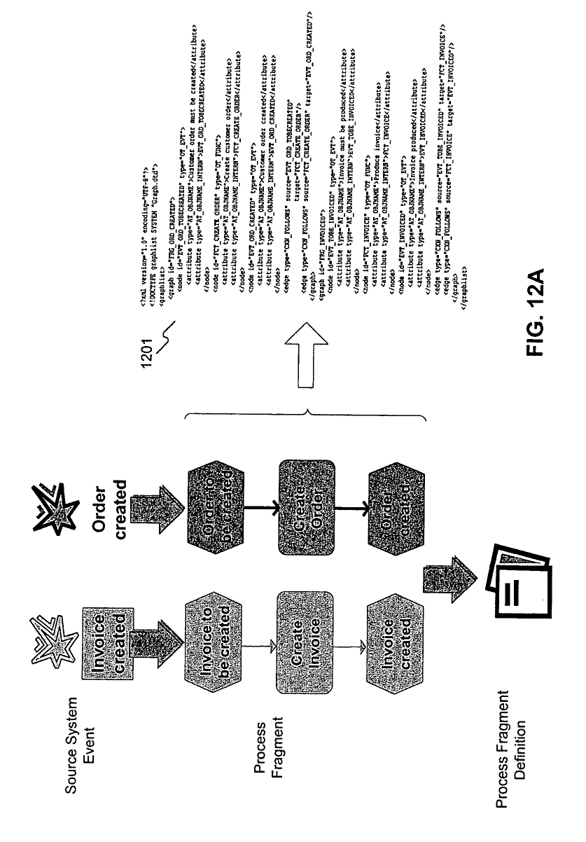

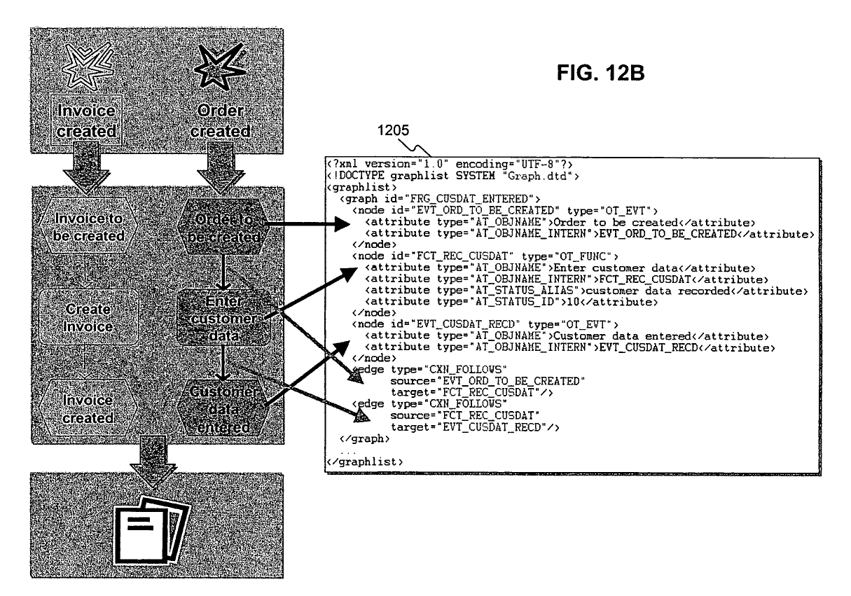

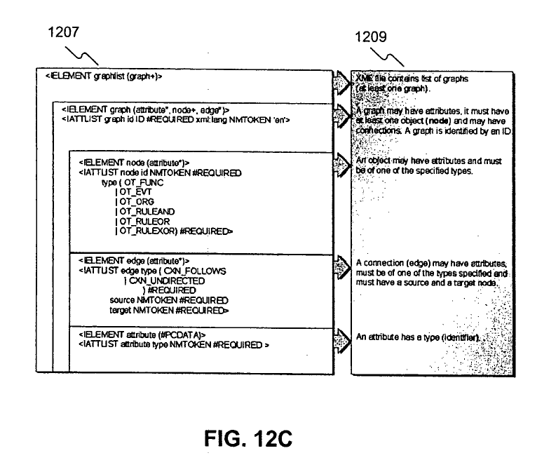

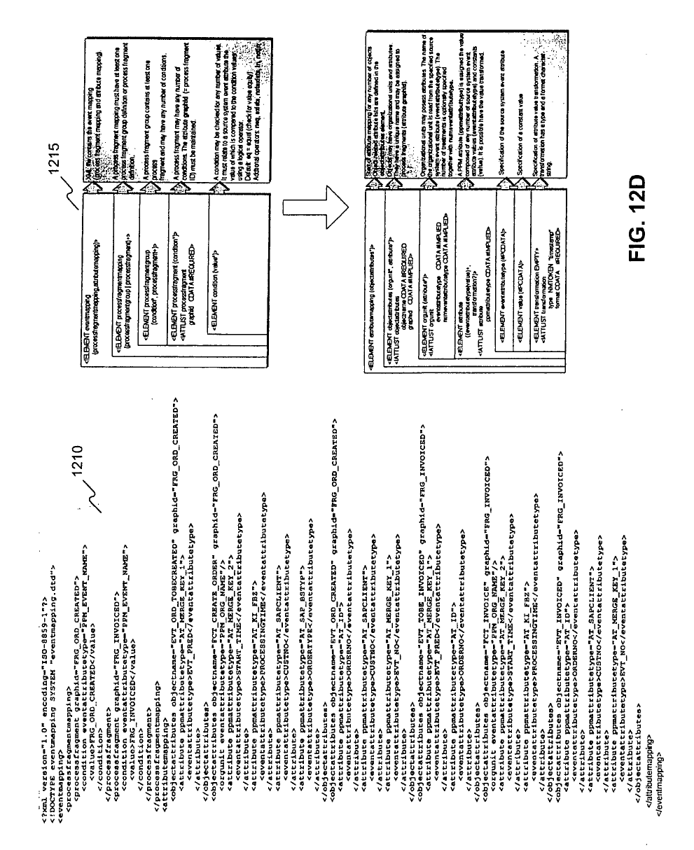

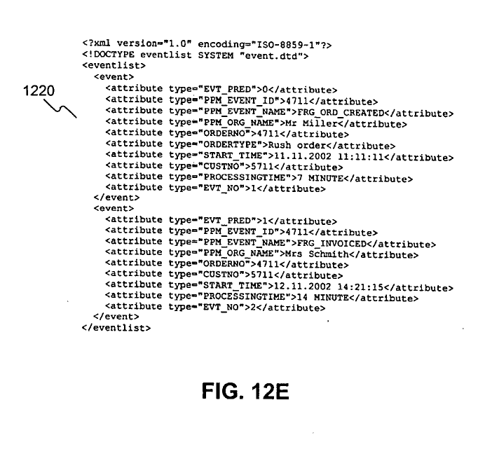

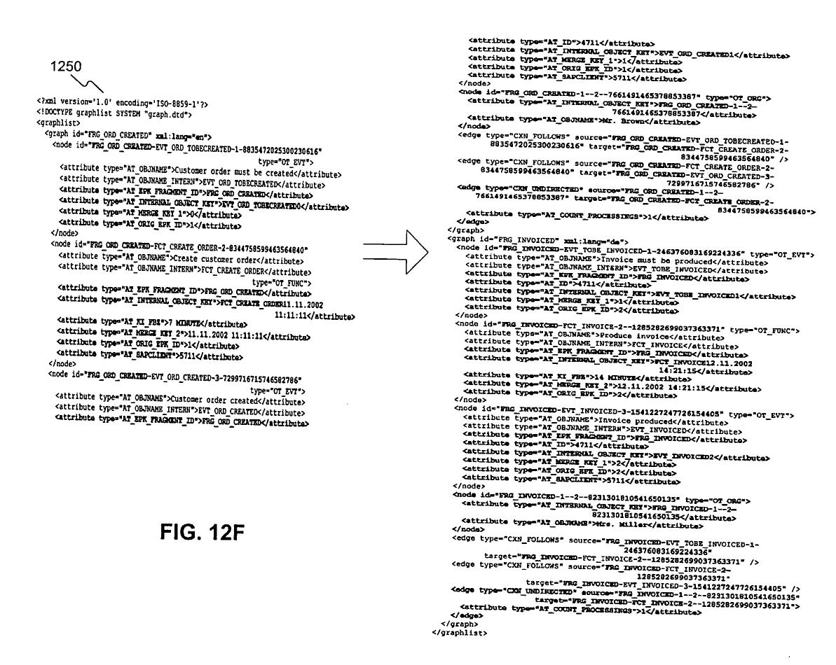

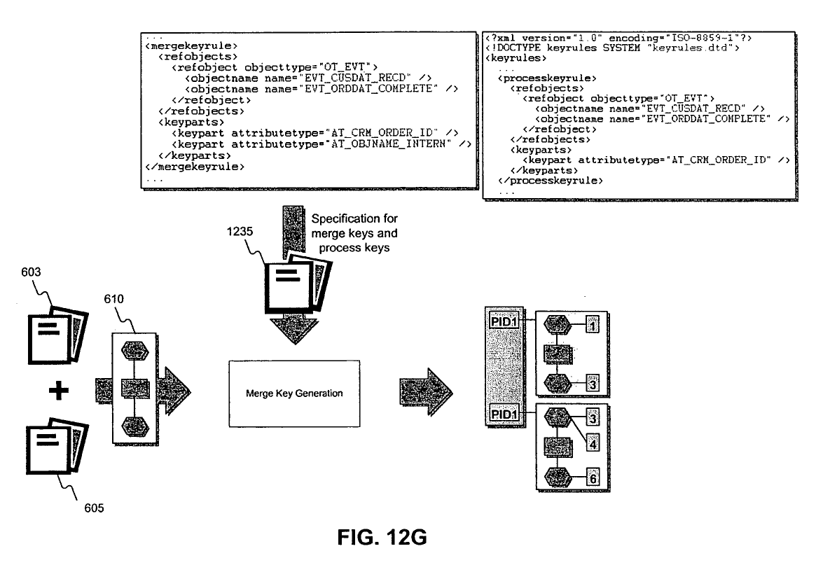

Process fragments may be generated from information obtained from source systems (e.g., runtime data or a data file) and process fragment definitions. Embodiments of the invention may, therefore, provide methods for establishing and maintaining process fragment definitions. In one implementation of the invention, process fragments definitions may be generated and stored in an established repository prior to obtaining information from source systems. In alternative implementations, however, process fragments could be defined dynamically during data acquisition or subsequent to data acquisition. Establishing process fragment definitions may include assigning source system events to a particular type. Examples of process fragment definitions are illustrated in FIG. 12A and discussed below in connection with that figure.

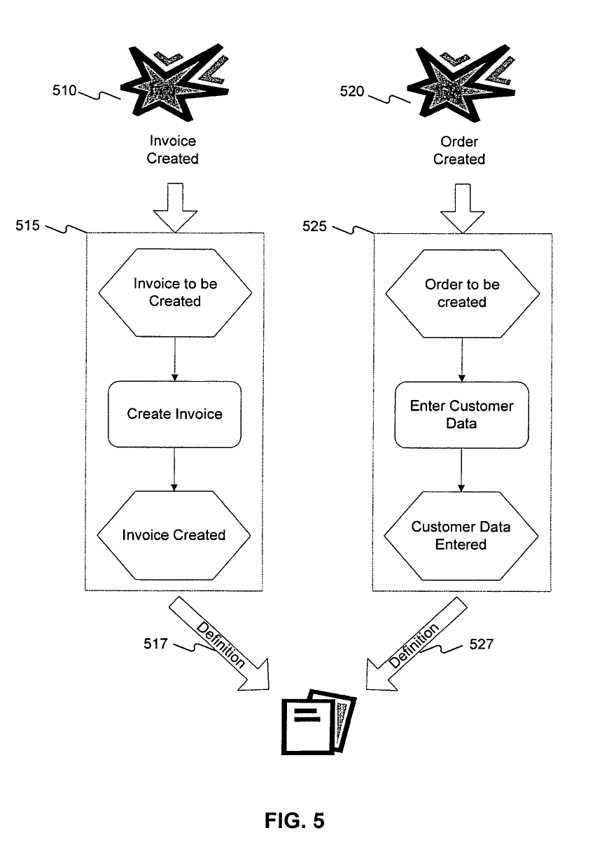

FIG. 5 illustrates exemplary aspects of defining process fragments consistent with embodiments of the invention. For purposes of illustration, two source system events (e.g., “Invoice Created” and “Order Created”) are presented in FIG. 5 to demonstrate the concept of defining process fragments. Of course, as will be appreciated by the reader, the aspects disclosed with reference to the examples of FIG. 5, as well as the other attached figures, may be applied to any type and number of source system events, consistent with the present invention.

As illustrated, process fragments 515 and 525 may be assigned to source event types 510 and 520 and may be defined by definitions 517 and 527, respectively. Consistent with aspects of the invention, every source system event (e.g., system status change) obtained may be assigned a process fragment. In one example, each source system event may be assigned to an end (resulting) event of a separate process fragment. The end event of a particular process fragment may therefore correspond to a source system event received. (In other embodiments, it may not be necessary for the source system event and the fragment end event to be the same.) In this fashion, defined process fragments may be generated from information obtained from a source system. For example, if information obtained from a source system (a source system event) corresponds to event type 510, then process fragment 515 may be generated in response to that information.

Consistent with principles of the present invention, every source system event obtained may be assigned a process fragment using a mapping definition, which may be included in a mapping list (e.g., a mapping file). A mapping list may specify assignments of source system event types to process fragment definitions and may determine attributes of the source system events, which may be copied to the fragments. That is, the mapping list may specify which source event types are to be assigned to which fragment definitions (fragment mapping) and also which attributes are to be transferred (attribute mapping). Like the process fragment definitions, mappings may be stored in an established repository, before information is obtained from source systems and logged. Additional details of mappings are discussed below in connection with, for example, FIG. 10.

Referring again to FIG. 3, generating process fragments (step 310) may involve searching for fragment definitions for obtained source system information. Information obtained from source systems (e.g., logged source system events) may be mapped (according to the fragment mapping) to process fragment definitions (e.g., in a definitions file), and these process fragment definitions may be copied and stored. Attributes specified in the attribute mapping with real data (e.g., execution time, processor, order number, customer number, sequential event number, etc.) may then be transferred/copied to objects in the identified and stored process fragment definitions, thereby generating process fragments. Additional details of generating process fragments are discussed below in connection with the examples of FIGS. 12A-12G.

After process fragments are defined and generated from information obtained from source systems, process fragments may be merged (step 320). Merging process fragments may involve combining and/or consolidating process fragments to generate a process instance. As used herein, the term “process instance” refers to a particular realization of given business process. A process instance may correspond to a business process that has actually been executed. That is, a process instance may represent an actual business activity that has occurred. In one example, merging may involve identifying process fragments belonging to the same instance. Merging process fragments may involve searching for identical or corresponding start and end events of each process and merging those events into a single event for connecting two consecutive fragments. Merging may include eliminating redundant events from several process fragments. In certain embodiments, merging process fragments may include merging fragments based on identifiers and in accordance with merge keys and rules.

Consistent with embodiments of the invention, merging process fragments may include assigning unique and consecutive process keys or identifiers (PIDs) to process fragments. PIDs may be defined in a specification file and may include symbols, values, tags, or any other identifying elements. In certain embodiments, merging process fragments may include merging all process fragments having identical process keys into a single resulting process instance. In certain embodiments, merging process fragments may involve establishing merge keys or identifiers for functions and events within process fragments. The merge keys may be defined in a specification file (along with the PIDs) and may include symbols, values, tags, or any other identifying elements. In certain embodiments of the invention, the ways in which merge keys and process keys are established and determined are set individually or tailored for each of a plurality of business process source systems.

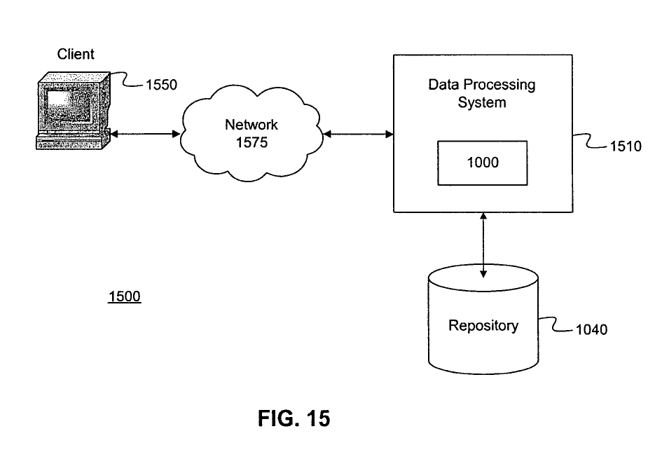

Merging process fragments may also include defining rules for merging process fragments. Merge rules may implemented in accordance with an established modeling convention (e.g., EPC) and may describe various connections between functions and events. Merge rules may include, for example, AND logic rules, OR logic rules, and XOR logic rules. Merge rules may also include guidelines for generating representations of business processes. Merge rules may specify how to handle process fragments and may include necessary information regarding how to identify corresponding events of process fragments in a logical order. Merge rules may or may not be configurable or customizable. Merge rules could be implemented in program logic on a server, such as server 1510 discussed below in connection with FIG. 15. Exemplary excerpts of merge key and process key settings and rule selections are shown in FIG. 12G. In one implementation of the invention, process keys may be assigned to process fragments in accordance with merge rules.

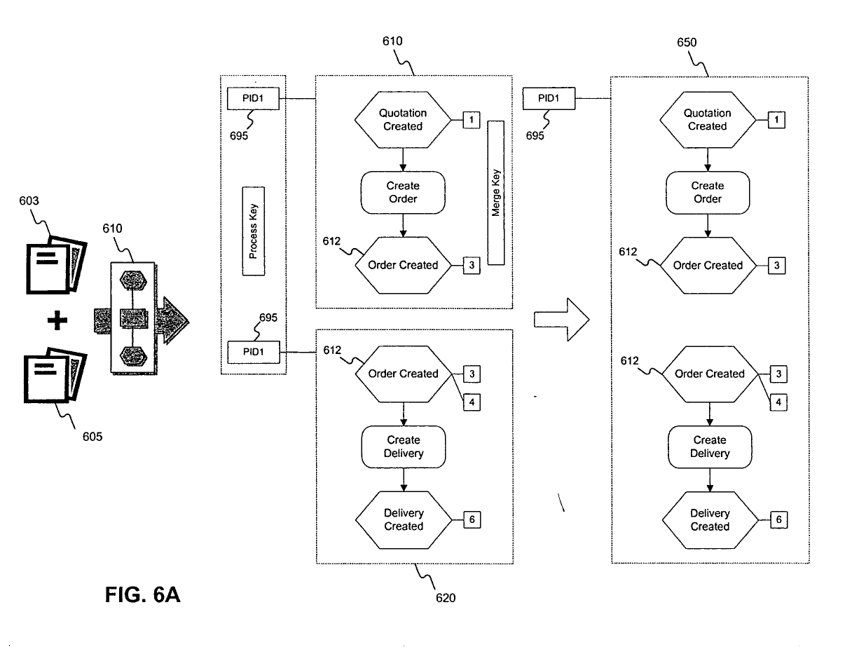

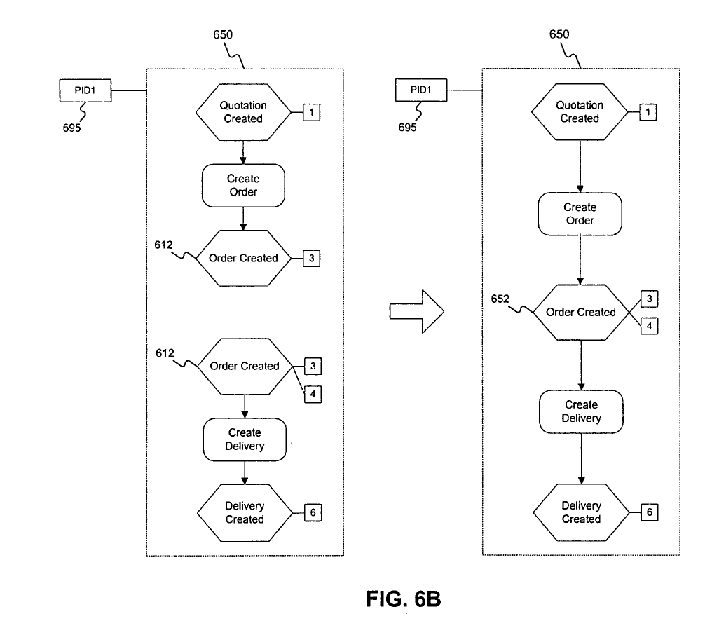

FIGS. 6A and 6B illustrate exemplary aspects of merging process fragments, consistent with embodiments of the present invention. As illustrated in FIG. 6A, information obtained from source systems (e.g., protocol file 603) and fragment definitions 605 may be used to generate a process fragment 610. Process fragment 610 (including its definition and imported information) may be assigned or “stamped” with a PID (e.g., PID 695). Process fragment 610 may be merged with other fragments (e.g., process fragment 620). As illustrated, fragments 610 and 620 may be merged because they have identical PIDs (i.e., PID 695). In addition, fragments 610 and 620 include corresponding or common events (i.e., event 612), and those events may be merged into one event for connecting the two fragments. As illustrated, event 612 may be an end event in fragment 610 and also a start event in fragment 620. Event 612 may, therefore, be a common event or “merge event” with respect to fragments 610 and 620. Event 612 from each fragment may, therefore, be consolidated to connect fragments 610 and 620.

Consistent with embodiments of the invention, process fragments 610 and 620 may be merged to produce a process instance 650. Further, as illustrated in FIG. 6B, redundant events may be eliminated within process instance 650. For example, event 612 from fragment 610 and event 612 from fragment 620 may be merged into a single event 652 within process instance 650.

Consistent with certain embodiments of the invention, merging process fragments to generate process instances may include copying attributes to the process instances. Process instance attributes may form a basis for the calculation of business process performance. In one embodiment, only objects and their attributes are taken into account and attributes of the fragments may be lost during fragment merging. Object attributes may, therefore, be copied to the process instances.

After process fragments are merged, process instances may be merged (step 330 in FIG. 3) to generate one or more process models. Merging process instances may include identifying those instances having a logical relation and combining them to produce a model of the business process. Merging process instances may involve fusing events. Merging process instances to generate a model may include generating a graphical representation of the business process.

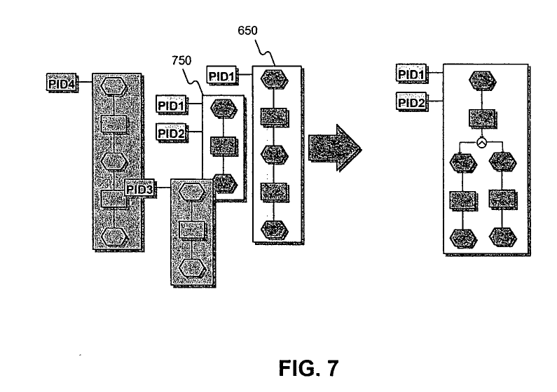

FIG. 7 depicts exemplary aspects of merging process instances into process models, consistent with embodiments of the present invention. As illustrated, process instance 650 may be merged with process instance 750. In at least one example, any branches arising from merging are extended using merge rules and any rules that have become unnecessary may be deleted. For instance, a joining XOR rule may be removed during a merge, since process instances may represent actual transaction and not contain XOR rules.

As explained above, information may be obtained from source systems in a plurality of different formats. In certain embodiments of the invention, reconstructing a business process may involve identifying a format of the information received from a source system. If the obtained information does not include information making up the process (i.e., the data is unstructured), process fragments may be generated using that information, as detailed above. That is, when a specific event is received from a source system, a corresponding process fragment, which is defined and assigned to that event, may be generated. Alternatively, source systems (e.g., workflow systems) may provide data in a structured or “graph” format, i.e., the data may include already completed process instances. (Generating process fragments may include configuring one or more source systems to provide structured information.) If information received from source systems is structured (i.e., includes process instances) reconstructing a business process (step 220) may not include all of the steps illustrated in FIG. 3. For example, steps 310 and 320 may not be required.

In certain embodiments of the invention, method and systems may generate process fragments, process instances, and process models from data stored in an established repository. That is, methods and systems may store, access, and retrieve information required to construct fragments, instances, and models in an established knowledge base. Further, generated process fragments, instances, and models may be stored in the knowledge base for further processing and use.

Business Process Analysis

Referring back to FIG. 2, embodiments of the present invention may provide methods and systems for analyzing business processes (step 230). Analyzing business processes may involve measuring business process performance and facilitating business process management and improvement. In at least one example, analyzing business processes may involve facilitating user interaction, to allow users to manage, monitor, and improve business processes. In one implementation of the invention, information may be provided to users in response to queries. Analyzing business processes may include proactively managing the efficiency of running business processes by measuring and analyzing those processes various performance metrics.

Measuring business process performance may include calculating “hard facts” (e.g., performance indicators) based on “soft facts” (e.g., recorded business processes). Measuring business process performance may involve executing one or more analyses on business process fragments, instances, and/or representations. Various business process analyses may be performed, including process performance management. Measuring business process performance may involve accessing, and retrieving information (e.g., generated business process representations) from, one or more knowledge bases and analyzing business processes based on that retrieved information.

Consistent with embodiments of the invention, measuring business process performance may include performing one or more performance indicator analyses. In such embodiments, methods and systems may establish and define one or more performance indicators, such as KPIs (key performance indicators). Performance indicators may include measurable and/or calculable properties of business processes and their functions (i.e., activities). In one embodiment, performance indicators may be calculated from one or more measured variables. Performance indicators may include a set of adjustable/configurable rules realized as formulas in a data file. Such formulas may be defined using various notations, such as the Reverse Polish Notation (RPN). Performance indicators may be predefined and/or manually configured. Measuring process performance may involve calculating performance indicators (e.g., KPIs) to analyze business processes based on information obtained from source systems (e.g., imported time-dependent data). Performance indicators may measure time, cost, quality of service, volume, reliability, etc. In certain embodiments of the invention, performance indicators may be classified accordance to type. For example, performance indicators may include process-based indicators and function-based indicators. These indicators may be further classified based on additional criteria.

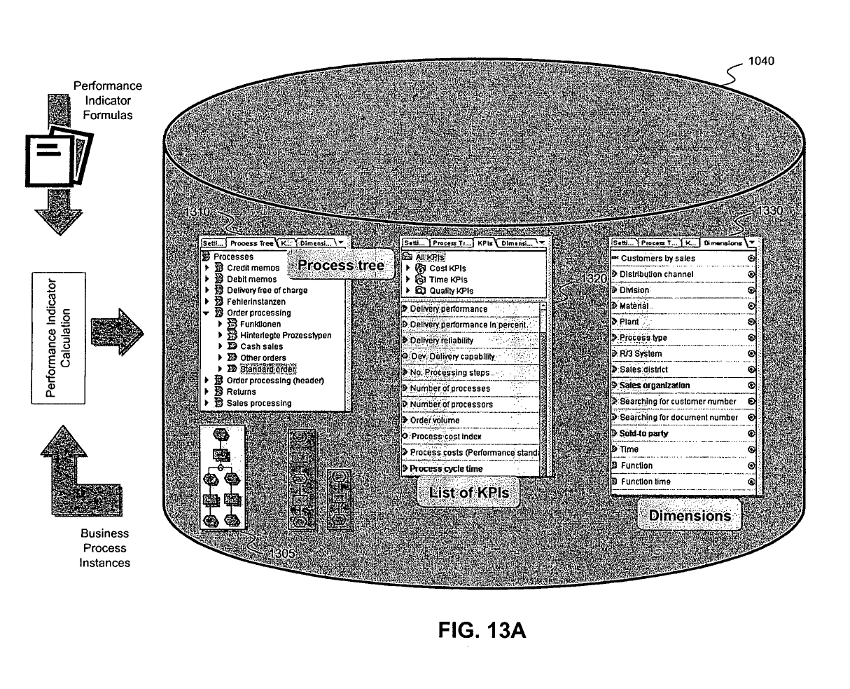

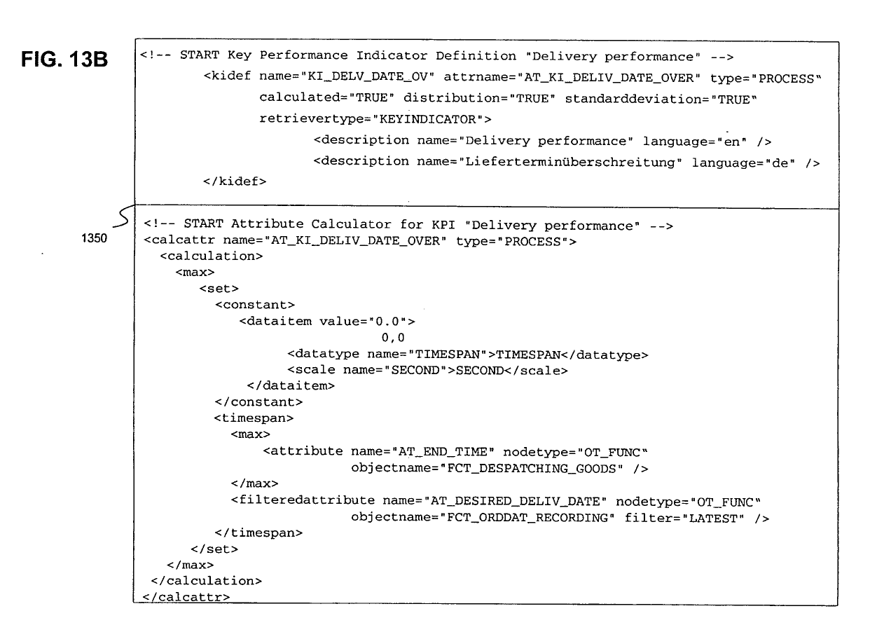

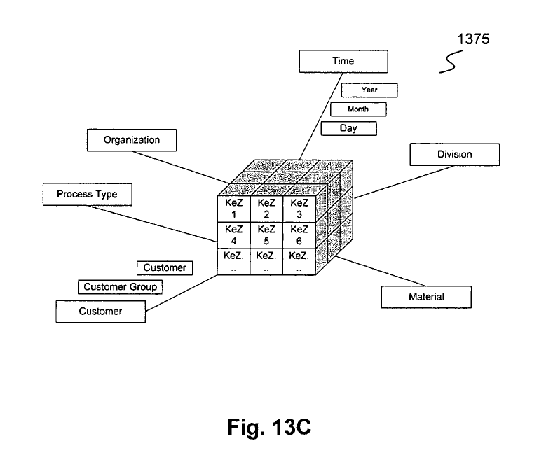

Measuring business process performance may involve establishing and implementing one or more dimensions, which may be used in conjunction with the calculation of performance indicators. As used herein, the term “dimension” refers to any criteria according to which performance indicators can be differentiated. Establishing dimensions may include specifying dimensions as differentiators of processes in a repository. In certain embodiments, dimensions may be specified and used for grouping and filtering during performance indicator calculation. Dimensions may be based on time, location, process type, products, customers, documents, etc. Exemplary implementations of performance indicators and dimensions are discussed below in connection with FIGS. 13A and 13B. In at least one example, filters may be specified for use with performance indicators. One exemplary filter may cause indicators to be calculated for process instances of completed business processes, while process instances of unfinished business processes may be stored for subsequent merging with missing business process portions.

In accordance with aspects of the invention, performance indicators may be calculated for every process instance including the functions (i.e., business process activity) to measure and analyze process performance. These performance indicators may form a basis for various business process performance analyses. In certain embodiments, after process fragments are merged into process instances, the process instances may be classified or typified in order to facilitate performance analyses. Classifying process instances may be performed immediately after process fragments are merged into instances (e.g., after step 320) or subsequently during business process performance measuring.

In certain embodiments, classifying process instances may include arranging process instances in a hierarchy. For example, processes may be arranged in a freely definable two-level hierarchy including types and groups. In one embodiment, process instances may be assigned to process “types,” which may in turn be classified into process type “groups.” A given process type group may contain a plurality of process types, and a given process type may contain several process instances. Consistent with embodiments of the invention, a given process instance may be assigned to a single process type (and thus to a single type group). Process types and type groups may be arranged in a process “tree” structure. An exemplary process tree (1310) is illustrated in FIG. 13A. Non-limiting examples of type groups may include: {Order processing}, {Credit memos}, {Debit memos}, {Delivery}, {Error instances}, {Returns}, etc. In one example, {Cash sales}, {Other orders}, and {Standard Order} process types may be assigned to the {Order processing} type group. Classifying process instances may involve establishing classification rules, which may be freely definable on a source system specific basis. Such rules may be established and maintained as process instance attributes.

For processes arranged in a given process tree, specific performance indicators may be calculated according to specified dimensions. The calculated results may then be stored in an established repository. In one example, the results may be stored in “info cubes,” additional details of which are discussed below in connection with FIG. 13C.

Consistent with aspects of the invention, analyzing business processes may involve establishing one or more process instance independent key performance indicators (PIKIs) and dimensions. Process instance independent data do not account for process-oriented aspects, such as customer satisfaction, commercial fixed costs, and financial characterizations of a business entity. PIKIs may include performance indicators that are calculated independent from data in individual process instances. That is, PIKIs may not be calculated from process instances. Instead, the PIKIs may be imported directly from associated dimensions without reference to instance data. In certain embodiments, PIKIs can form a basis for user-defined performance indicators and combined with process instance dependent performance indicators.

In accordance with aspects of the invention, PIKIs may be leveraged to extend the value range of instance-dependent performance indicators. PIKIs may be used to analyze business processes when instances related data is unavailable. For example, PIKIs may be used to analyze process cycle time for a designated time period (e.g., 1990-1999) when process instance related data for that time period is unavailable and only average values recorded on a monthly basis are accessible. The average value data may be retrieved as PIKIs and evaluated in conjunction with a specified process performance indicator (e.g., a “process cycle time” indicator).

Analyzing business processes (step 230) may include generating trend analyses for business process owners, detail analyses for employees, business process cycle time analyses, top/flop analyses, yield tables, quartile analyses, customer churn rates, etc. In at least one example, analyzing business processes may include performing multi-dimensional analyses of information obtained from source system. Analyzing business processes may include modeling business processes across dimensions, as well as performing trend analyses over various time periods. Embodiments of the present invention may provide individual business process representations, as well as any number of business process representations on an aggregated basis. Analyzing business processes may include aggregating more than one business process in order to identify one or more business process patterns or trends. For example, business processes may be aggregated to determine an average value of behavior patterns of one or more business processes. Analyzing business processes may also include organizing data hierarchically, enabling users to explore detailed information (e.g., details of a specific business process), as well as broader views (e.g., overall spending, customer satisfaction, overall business process performance, etc). In addition, analyzing business processes may involve dynamically changing combinations of dimensions viewed by a user. Consistent with certain embodiments of the invention, performance analysis results may be stored in an established knowledge base.

Consistent with embodiments of the present invention, analyzing business processes may involve facilitating business process monitoring. In at least one example, planned and alarm values may be defined to allow monitoring. Planned values may relate to a set of process instances, while alarm values may related to an individual process instances. Critical upward or downward alarm value infringements may occur for individual process instances, even though planned values for the set of instances are met. Analyzing business processes may include monitoring or checking for upward and downward infringement of target values for individual performance indicators.

In accordance with aspects of the present invention, methods and systems may facilitate user interaction. Facilitating user interaction may include providing users with information related to business processes and performance measurement results. For example, methods and systems may provide business process model and/or analysis information to one or more users (e.g., a business entity). Providing information may include any form of information transfer. In certain embodiments, methods and systems may provide users with presentations of a business process. A “presentation” may include any depiction, portrayal, or model of a business process including, visual (e.g., graphical) illustrations, audible presentations, simulations, virtual demonstrations, etc. Embodiments of the present invention may provide individual business process representations, as well as any number of business process representations on an aggregated basis.

In certain embodiments of the invention, facilitating user interaction may involve executing one or more actions in response to specific business process performance measurement results. For example, in response to an alarm value infringement, one or more users may be notified (e.g., via e-mail) of the infringement.

Facilitating user interaction may include allowing users to monitor processes and performance analyses on a continual basis, notifying users of specific occurrences (e.g., alarm value infringements) and/or analyses results, and allowing users to investigate business processes and analyses. Facilitating user interaction may also include allowing users to specify or manipulate analysis criterion, dimensions, filters, and other configurable parameters. In addition, facilitating user interaction may include allowing users to initiate one or more analyses, store information, and retrieve information.

In at least one example, a user interface or “frontend” may be provided through which users can identify, access, manipulate, and/or view business process model and analysis information. In certain embodiments, providing a user interface may include providing any type of business process presentation to one or more users. Providing a user interface may involve establishing and/or configuring one or more websites maintained by one or more computer systems. In at least one example, a client-server architecture may be established in which a client can view business process analyses performed on the server.

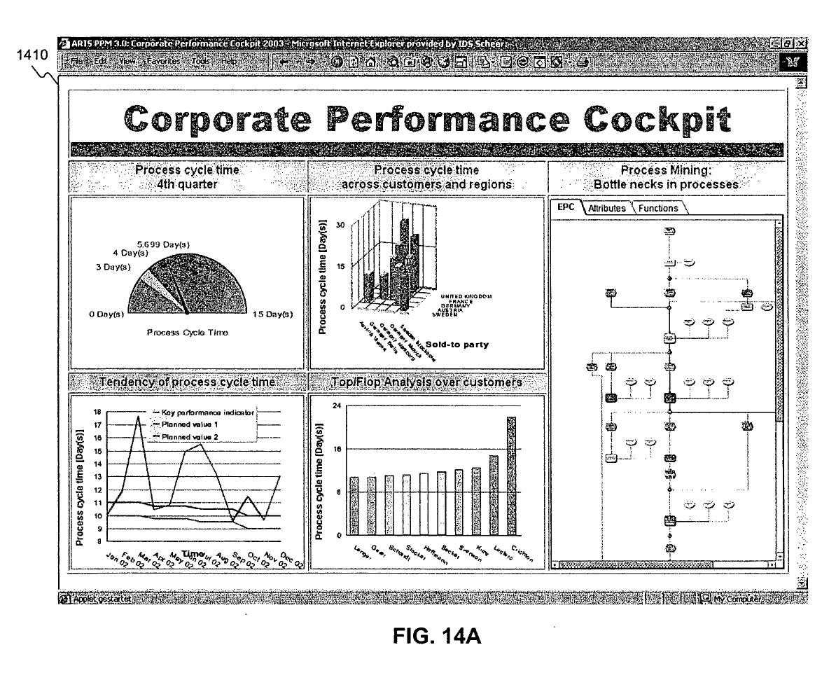

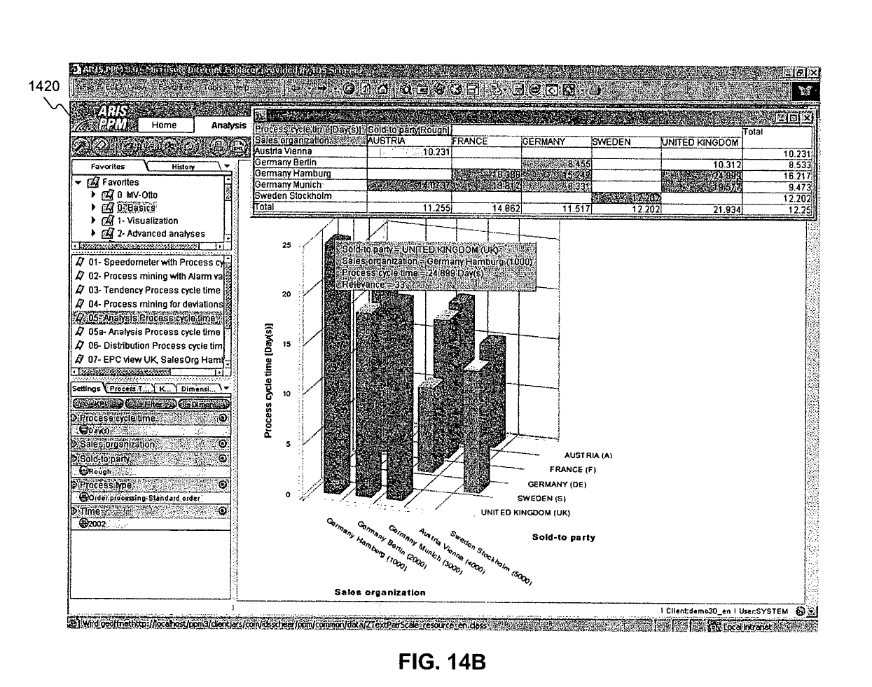

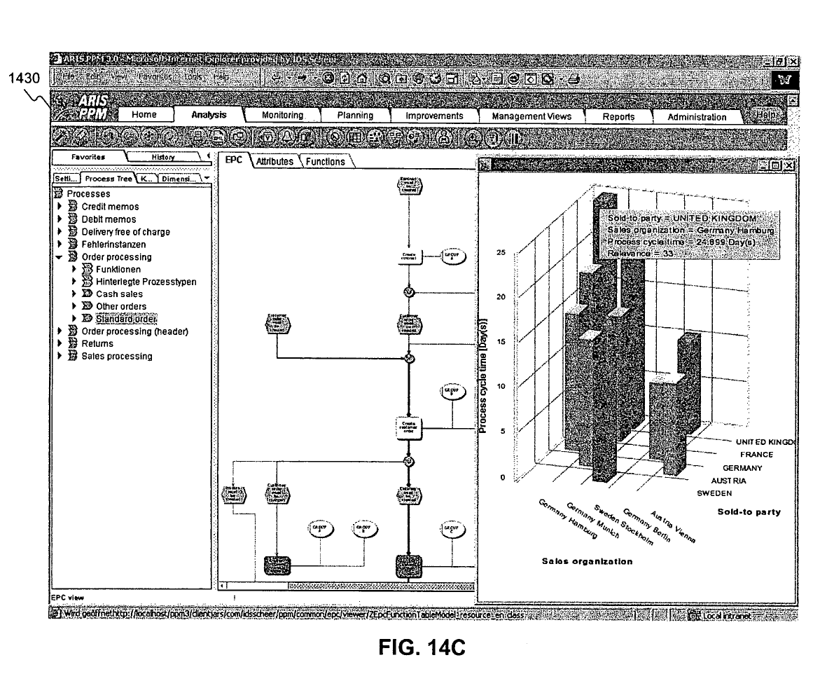

Consistent with principles of the instant invention, providing a user interface may include providing varying levels of information accessibility. For example, analyses information may be viewable based on an access level assigned to a particular user. Further, providing a user interface may include providing varying “views” of analyses results for different groups within a business entity. Providing views may include presenting different result information to different groups, respectively, within a business entity. Providing views may also include providing different groups with the same information but providing that information in different formats for different groups. In one example, a “management” or “cockpit view” may provide full access to all analysis results and business process models, while an “employee view” provides specific operational result information. An exemplary user interface/front-end is detailed below in connection with FIGS. 10 and 14A-14C.

Providing a user interface may include providing features including, but not limited to, data access and searching, categorization, personalization options, data profiling, etc. Users may also perform business process mining. Embodiments of the present invention may enable a client/user to select an analysis criteria (e.g., particular performance indicators and dimensions) and access various analysis results. In one example, users may drill-down through layers of analysis information. A user may drill-down from the performance indicator analysis results to underlying aggregated processes or to a single process instance. Consistent with principles of the present invention, “hard facts” (i.e., performance indicators) are connected with “soft facts” (i.e., recorded business processes), thereby allowing users to switch between performance indicator analysis and process analysis.

Consistent with aspects of the present invention, analyzing business processes may facilitate business process decision making. For example, users may view analysis results in order to make cost/benefit decision, market decisions, and/or a strategic business decisions. Moreover, performance measurement results may facilitate business process improvement. For example, upon viewing analysis results, business process owners may modify or streamline current processes based on the results.

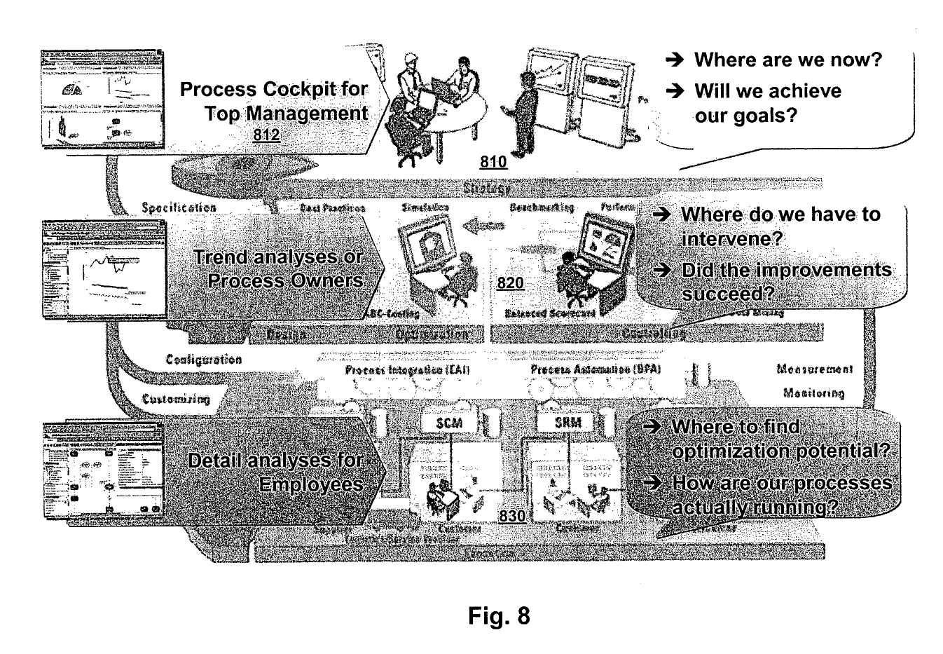

In at least one example, business process analysis results may be provided to various target groups within one or more business entities. FIG. 8 illustrates exemplary aspects of providing results to target groups, consistent with embodiments of the present invention. As illustrated, top management (target group 810) may view overall process performance results (e.g., via cockpit view 812) in order to make strategic management decisions. In addition, process owners (target group 820) may view trend analyses in order to determine business process effectiveness and intervention strategies. Employees (target group 830) may view detailed analyses tailored for them in order to streamline and optimize process implementation.

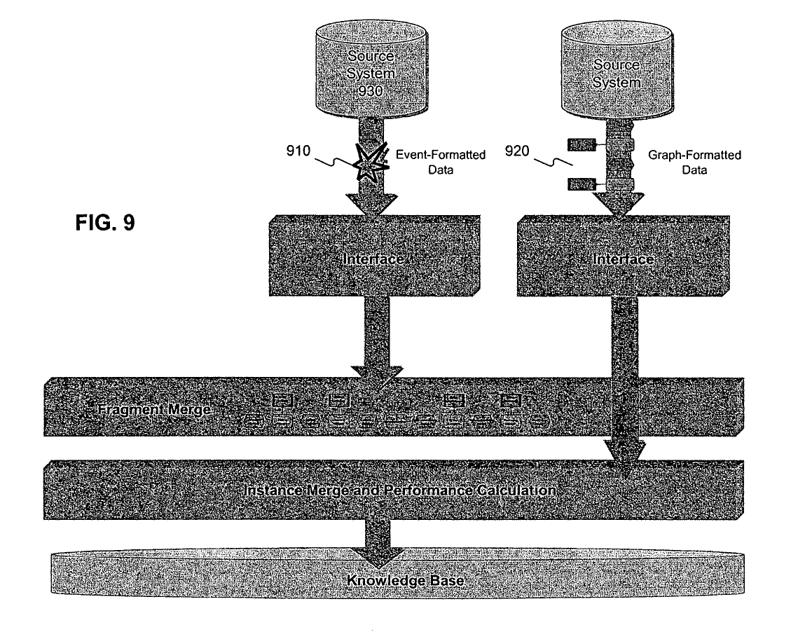

FIG. 9 graphically depicts exemplary aspects of obtaining information, reconstructing business processes, and analyzing business processes, consistent with embodiments of the present invention. As illustrated, event-formatted and graph-formatted information (910, 920) from source systems (930, 940) may be processed and used to measure business process performance. In certain cases, the generation and merging of process fragments may not be required depending on the format of the data from the source system (i.e., if the source data is graph-formatted).

FIGS. 2-9 are consistent with exemplary embodiments of the present invention. The sequence of events described in connection with the figures are exemplary and not intended to be limiting. Other steps may be used, and even with the methods depicted, the particular order of events may vary without departing from the scope of the present invention. Further, the illustrated steps and functionality may overlap and/or may exist in fewer steps. Moreover, certain steps may not be present and additional steps may be implemented in the methods illustrated. In addition, the illustrated steps may be modified with departing from the scope of the present invention.

Exemplary System

FIG. 10 is a block diagram of an exemplary business process management (PPM) system 1000, in which features and aspects consistent with the present invention may be implemented. The number of components in system 1000 is not limited to what is shown and other variations in the number of arrangements of components are possible, consistent with embodiments of the invention. In certain implementations of the invention, business process management system 1000 may embody the functionality and data import facility of, for example, the ARIS Process Performance Manager, available from IDS Scheer AG (Saarbrücken, Germany).

As illustrated in FIG. 10, system 1000 may comprise a source interface module 1015, a processing module 1020, a repository 1040, and a user interface module 1050. Modules 1015, 1020, 1040, and 1050 may, in at least one example, include functional logic to implement one or more of the methods described in connection with, for example, FIG. 2.

Source interface module 1015 may serve as a gateway through which information can be transferred from business process source systems (1095A-1095N) to one or more elements within PPM system 1000. Source interface module 1015 may be implemented by one or more software, hardware, and/or firmware components. Source interface module 1015 may also include and/or leverage one or more logical components, processes, algorithms, systems, applications, and/or networks. Source interface module 1015 may include and/or leverage one or more data ports for transmitting and receiving data from one or more source systems and PPM system 1000. Certain functions embodied by source interface module 1015 may be implemented in, for example, eXtendable Markup Language (XML), HTML, HTML with JavaScript, C/C++, Java, etc.

Consistent with principles of the present invention, source interface module 1015 may be “generic” in that it can interact with a plurality of distinct source systems, thereby allowing PPM system 1000 to interact with source systems without using a plurality of source-specific interfaces. In one configuration, source interface module 1015 may include an import interface implemented in XML. The Standard Generalized Markup Language (SGML) and/or any other language that facilitates the creating and sharing of common information formats may also be employed. Further, in certain embodiments, ebXML (Electronic Business XML) may be leveraged by source interface module 1015. Interface module 1015 may additionally include and/or leverage one or more validation processes and languages, such as Tree Regular Expressions (TREX).

Source interface module 1015 may be configured to continually monitor business process source systems 1095A-1095N and extract and/or receive information on a continual basis or at predetermined intervals. In certain configurations, source interface module 1015 may interact with one or more applications running on one or more computer systems. Source interface module 1015 may include components that embed functionality associated PPM system 1000 within such computer applications. In one example, interface module 1015 may embed functionality within a computer application that enables that application to provide information to interface module in a particular structure. Also, in certain configurations, source interface module 1015 may facilitate communication between programs running in varying operating systems by leveraging, for example, Simple Object Access Protocol (SOAP) services.

Consistent with embodiments of the present invention, source interface module 1015 may be configured to accept information from source systems 1095A-1095N in a plurality of formats and arrangements, which may be predefined, manually configured, and/or programmed by interface 1015. Source interface module 1015 may, in certain configurations, be operable to receive information from source systems 1095A-1095N in various formats, including XML and CSV (comma-separated values) or other flat file formats. Consistent with principles and aspects of the invention, source interface module 1015 may accept graph-formatted (structured) and event-formatted (unstructured) data from source systems 1095A-1095N.

Each business process source system (1095A-1095N) may be operable to provide information in the form of time-stamped data. In certain configurations, source interface module 1015 may extract a single data record/element as a representation of each business process activity (following a chronological order indicated by such time-stamps) and generate a corresponding log or protocol file.

FIG. 11A depicts aspects of an XML-based protocol or log file 1100 consistent with embodiments of the present invention. As illustrated in the example of FIG. 11A, file 1100 may contain one or more sets of data records (1125) for each EPC event from source systems 1195A and 1195B. File 1100 may include information associated with one or more event types, for example, an “Order Received” event and an “Invoice Created” event. The protocol or log file may contain the actual instance information about the actual course of a business process. Consistent with embodiments of the present invention, the log file may be structured and/or formatted according to one or more Document Type Definition (DTD) files. In certain configurations, source interface module 1015 may be operable to store obtained information and log files in repository 1040, the details of which are discussed below.

For purposes of illustration, FIG. 11B provides additional exemplary excerpts of a log file 1125 for the event types “Invoice Created” and “Order Produced.” Consistent with embodiments the present invention, the log file 1125 may be an XML-based log file. The format of the log file 1125 may be specified by the exemplary DTD file 1150. As indicated by the summary 1152 in FIG. 11B, the exemplary XML file in this example is specified as containing a list of source systems events, the list containing at least one source system event. Global attributes applied to each event element may be specified. Further, each source system event has at least one attribute, and source system events can have organizational units and be identified by an ID and a name.

Processing module 1020 may perform business process modeling, performance indicator calculations (e.g., KPI and PIKI calculations), and other processing using information obtained from source interface module 1015. Consistent with principles of the present invention, processing module 1020 may facilitate On-line Analytical Processing (OLAP) and may support multi-dimensional analyses of data. Further, processing module 1020 may perform calculations and modeling across dimensions as well as trend analysis over various time periods. Processing module 1020 may also perform data mining (e.g., process mining). In at least one example, processing module 1020 may enable users to explore detailed information (e.g., details of a specific transaction), as well as broader views (e.g., overall performance, etc). In certain configurations, processing module 1020 may facilitate data warehousing which includes data replication, data transformation, data quality assurance, data storage, metadata storage, and data mart population (i.e., populating specific databases within a data warehouse).

Processing module 1020 may be implemented by one or more software, hardware, and/or firmware components and may include and/or leverage one or more logical components, processes, algorithms, systems, applications, and/or networks. In one example, functions embodied by processing module 1020 may be implemented in, for example, HTML, HTML with JavaScript, C/C++, Java, etc. As illustrated, processing module 1020 may further comprise a model generator 1025 and a calculation module 1030.

Model generator 1025 may generate one or more representations (e.g., graphical, textual, audible, virtual, etc.) of business processes based on the information received source systems 1095A-1095N via interface 1015. Processing module 1020 may be operable to interact with repository 1040 to retrieve the obtained information (e.g., in a stored log). In addition, processing module 1020 may be operable to receive information (e.g., a log) directly from source interface 1015. Model generator 1025 may process the obtained information in order to generate one or more process representations. Model generator 1025 may generate process fragment and process instances. As illustrated in FIG. 10, model generator 1025 may leverage a merger module 1027 and a classification module 1029 in order to generate business process representations.

Merger module 1027 may receive data obtained by source interface module 1015 and process that data in order to facilitate business process modeling. In one configuration, merger module 1027 may generate process fragments. For example, merger module 1027 may receive event-formatted data corresponding to source system events (e.g., in a protocol file) and may generate process fragments from that event data. To do so, merger module 1027 may leverage process fragment definitions and mapping information (which may be stored in repository 1040) to generate the fragments. Process fragment definitions may be utilized to identify each source system event to be imported. A fragment definition may be created for each source system event type. A mapping file may contain the assignment of the source system event types to process fragment definitions. It may determine the attributes of the source system events, which are copied to the process fragments for which an instance is generated. Consistent with the invention, various rules for the structure of process fragments, process fragment mappings, and attribute mappings may be specified. Fragment definitions and mappings may be realized using XML. In at least one example, rules for the structure and/or format of XML-based process fragment definitions and/or mappings may be specified in one or more DTD files.

FIGS. 12A and 12B illustrate exemplary excerpts from fragment definition files (1201, 1205), consistent with embodiments of the invention. In the example of FIG. 12A, two event types are shown: “Invoice Created” and “Order Created.” The fragment definition file 1201 in FIG. 12A may be an XML-based file and contain fragment definitions for the illustrated event types. FIG. 12B provides further exemplary excerpts for a fragment definition file 1205. Like the example in FIG. 12A, fragment definition file 1205 may be an XML-based file. For the example of FIG. 12B, the exemplary excerpts of file 1205 are for the event type “Order Created.”

Referring to FIG. 12C, an exemplary DTD file 1207 is shown. As disclosed herein, DTD files may specify the format/structure for XML files, such as XML files in graph format or containing XML-based fragment definitions. In the example of FIG. 12C, DTD file 1207 may specify the format for an XML file in graph format (comprising, e.g., graphs of linked objects (event-function-event)). As indicated by the summary 1209, the graph may be specified as having at least one object (node) and connections. Further, the graph may be identified by an ID and have attributes. An object may also have attributes and be one of several specified types (e.g., OT_EVT, OT_ORG, OT_RULEAND, OT_RULEOR, etc.). Moroever, a connection (e.g., an edge defining object relationships) may have attributes and be of one of several specified types.

FIG. 12D illustrates exemplary excerpts from an XML mapping definition file 1210 consistent with embodiments of the invention. The XML mapping definition file 1210 may be used in combination with, for example, the exemplary fragment definition file 1201 of FIG. 12A. FIG. 12D also illustrates exemplary excerpts from a DTD file 1215 containing, by way of example, rules for the structure of XML-based process fragment mapping, as well as XML-based attribute mapping.

As noted above, when importing data, a search may be performed for the fragment definition corresponding/assigned to each source system event in a received log file. For example, system 1000 may search for fragment definitions for each source system event listed in a log file, such as the exemplary log file 1220 at depicted in FIG. 12E. These definitions may then be copied into a repository (e.g., 1040). Attributes of the events including real data (e.g., execution time, customer number, etc.) can then transferred to objects in the copy of the definitions, generating a process fragment in the repository that corresponds to the source system events in the log file. An exemplary listing 1250 of process fragments that may result from fragment definition file 1201, mapping definition file 1210, and a log file (e.g., 1220) is shown in FIG. 12F.

Merger module 1027 may merge generated fragments into process instances, which may be further merged to generate business process models. Merger module 1027 may perform merging operations using merge keys, process keys (PIDs), and merge rules (which may also be stored in repository 1040). Merger module may, in one example, assign process keys and/or merge keys to process fragments in accordance with merge rules, to facilitate fragment and instance merging. Exemplary excerpts of merge key and process key settings and rule selections are shown in FIG. 12G. In one configuration, merger module 1027 may be configured to merge process fragments and instances, in a manner consistent with the methods detailed above in connection with FIGS. 2 and 3.

Classification module 1029 may classify or typify process instances generated from process fragments. Classification module 1029 may, for example, arrange instances in an established hierarchy (e.g., types and groups). Classification module 1029 may, in one configuration, arrange instances using a tree structure. Classification module 1029 may leverage one or more source system specific classification rules, which may be included in process instance attributes and/or maintained in repository 1040. Classification module 1029 may perform classification operations on process instances immediately after they are generated by merger module 1027 and/or subsequently in conjunction with calculation module 1030. Further, although depicted as a discrete element, classification module 1029 may be embodied by merger module 1027 and/or calculation module 1030.

Calculation module 1030 may perform one or more analyses using information obtained from one or more source systems 1095A-1095N. Calculation module 1030 may leverage modeling module 1025 to perform analyses. In one example, calculation module 1030 may perform analyses using business process models generated by model generator 1025. In addition, calculation module 1030 may operate in conjunction with modeling module 1025 to perform analyses. For example, calculation module 1030 may perform analyses on process fragments or instances.

Calculation module 1030 may perform one or more performance indicator analyses based on predefined and/or manually configured performance indicator formulas or definitions. In certain embodiments, specific performance indicators may be calculated according to specified dimensions and/or filters. FIG. 13A illustrates exemplary performance indicators 1320 and dimensions 1330 maintained in a repository (e.g., 1040) consistent with embodiments of the present invention. As illustrated, performance indicators may be calculated across various dimensions for consolidated process instances 1305 stored in the repository. FIG. 13B illustrates an exemplary performance indicator formula 1350, consistent with embodiments of the invention. The illustrated formula is implemented in XML and defines a time span between two transactions. In at least one example, arbitrarily configurable performance indicators may be calculated for each process instance to measure and analyze process performance. Calculation module 1030 may also apply filters (e.g., stored in repository 1040) during performance indicator calculation. Consistent with embodiments of the present invention, performance indicator calculations may be stored in multidimensional data structures following certain data warehouse conventions for later retrieval and analysis. In at least one example, the results may be stored in “info cubes.” An “info cube” refers to a database structure in which information is stored similar to the star-schema or even snowflake-schema know from OLAP-databases. FIG. 13C illustrates an exemplary info cube 1375, consistent with embodiments of the invention.

Repository 1040 may provide a knowledge base for PPM system 1000. In certain embodiments, one or more of modules 1015, 1020, and 1050 may leverage repository 1040 to perform their respective functions. Repository 1040 may be configured to provide data warehousing functions for PPM system 1000. Repository 1040 may be operable to store, for example, numeric information, textual information, audible information, graphical information, etc. Repository 1040 may store information for one or more of modules 1015, 1020, and 1050. Repository 1040 may store information obtained from source systems; generated process fragments, instances, and models; analysis results; user profiles; performance indicator definitions; process fragment definitions; dimensions; filters; identifiers; correlation tables; etc. PPM system 1000 may leverage one or more leverage various data formatting schemes so that information can be transferred to and from repository 1040. For example, PPM system 1000 may leverage CSV and/or XML. In certain embodiments, each module in PPM system 1000 may use the same formatting scheme. One or more modules may use distinct formatting schemes, however, and one or more modules may be operable to perform format conversion operations.

Repository 1040 may be embodied by various components, systems, networks, or programs and may include one or more software, hardware, and/or firmware elements. Repository 1040 may represent one or more structured data archives distributed among one or more network-based data processing systems. Repository 1040 may be multidimensional in that it may organize data hierarchically and across several dimensions. Repository 1040 may include and/or leverage one or more schemes (e.g., file systems) for managing stored information. In certain configurations, repository 1040 may leverage one or more elements from a storage area network (SAN). Repository 1040 may include one or more relational databases and management systems (e.g., Oracle databases, DB2, MS SQL, etc.), distributed databases, object-oriented programming databases, and/or any other mechanism, device, or structure for managing, accessing, and updating an aggregation of data.

User interface module 1050 may serve as a gateway or front end (e.g., a communications portal) through which one or more users can interact with PPM system 1000. User interface module 1050 may include and/or leverage one or more Graphical User Interfaces (GUIs). User interface module 1050 may include and/or leverage one or more intranet websites, extranet websites, and Internet websites, or a combination thereof. In certain implementations, user interface module 1050 may be distributed among a plurality of clients in a client/server architecture. An exemplary architecture consistent with the invention is described below in connection with FIG. 15.

User interface module 1050 may allow users (e.g., business entities) to initiate one or more business process performance analyses and view the results of those analyses. User interface module 1050 may also allow users to instruct PPM system 1000 to store certain information and retrieve stored information (e.g., results of previous analyses). User interface module 1050 may allow users to identify, access, and view business process instances, models, presentations, analysis information, and reports (which may be stored in repository 1040). User interface module 1050 may enable a client/user to select analysis criteria (e.g., particular performance indicators and dimensions) and access various analysis result views. User interface module 1050 may also allow users to specify definitions (e.g., performance indicator formulas, fragment definitions, etc.) and modify dimensions, filters, and other configurable parameters.

User interface module 1050 may provide features including, but not limited to, user authentication and validation, data access and searching, categorization, personalization options, data profiling, etc. User interface module 1050 may also provide monitoring features that allow, for example, online monitoring of business processes on a continual basis. In certain configurations, user interface module 1050 may provide reporting and notification features, which may allow it to automatically retrieve and/or generate reports and deliver those reports (or notices of their status) to users (e.g., via e-mail, etc.) based on pre-configured (e.g., user-designated) settings. Additionally, user interface module 1050 may be configured to deliver specific reports to users at predetermined intervals (e.g., quartile reports).

User interface module 1050 may allow users to view performance indicator analysis results, as well as underlying aggregated processes or a single process instance. User interface module 1050 may also allow users to perform business process mining. FIGS. 14A-14C respectively illustrate exemplary screen shots 1410, 1420, and 1430 consistent with those that may be generated by user interface module 1050.

Consistent with principles of the invention, user interface module 1050 may provide varying levels of access to information and varying information views (e.g., management cockpit, etc.). User interface module 1050 may include components for performing user authentication and authorization. In one implementation, user authentication may be performed via logon passwords. For example, a user may register, or be registered by a business entity, using an assigned or self-declared password. Other mechanisms for performing user authentication may be employed such as a public key infrastructure (PKI) employing public key cryptography. Different users may be provided varying levels of authorization. For example, user interface module 1050 may restrict certain users from accessing particular information. Further, certain users may be assigned different rights. Certain users may be allowed to initiate analyses, access, store, and reproduce information, alter parameters, and modify dimensions and filters, while others may be restricted to viewing results.

For purposes of explanation only, aspects of PPM system 1000 are described with reference to the discrete functional modules, sub-modules, and elements illustrated in FIG. 10. The functionality of the illustrated elements, modules, and sub-modules, however, may overlap and/or may exist in a fewer or greater number of elements, modules, and/or sub-modules. Moreover, all or part of the functionality of the illustrated components may co-exist or be distributed among several geographically-dispersed locations.

Exemplary Environment

FIG. 15 is a block diagram of an environment 1500, compatible with features and aspects of the present invention and in which methods and systems consistent with embodiments of the present invention may be implemented. As illustrated in FIG. 15, environment 1500 may include a data processing system 1510, a client 1550, and a network 1575. The number of components in environment 1500 is not limited to what is shown and other variations in the number of arrangements of components are possible, consistent with embodiments of the invention. Consistent with principles of the invention, environment 1500 may comprise any number of geographically-dispersed clients (1550) and data processing systems (1510).

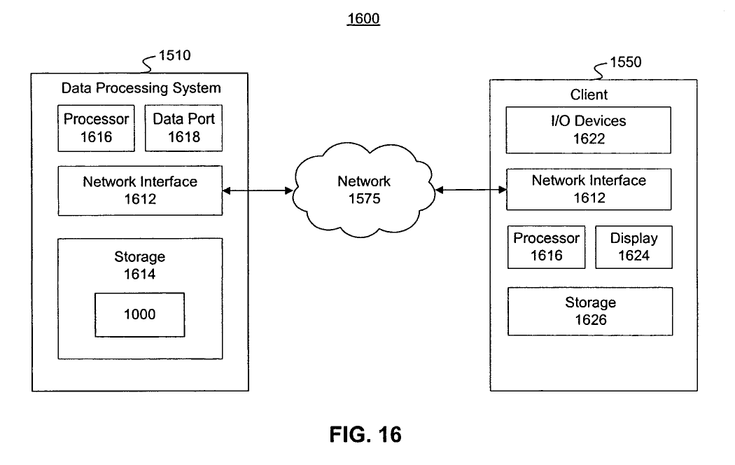

Data processing system 1510 may represent a server system (e.g., a Windows XP server) or a personal computer system. An exemplary configuration of data processing system 1510 is illustrated in FIG. 16 and detailed below in connection with that figure. As illustrated in FIG. 15, PPM system 1000 may be implemented in data processing system 1510, with repository 1040 embodied external to the other PPM system modules. Although depicted as coupled to data processing system 1510 in FIG. 15, repository 1040 may be distributed among various systems and/or may be included in or coupled to network 1575. In certain embodiments, however, one or more elements of PPM system 1000 may be distributed among one or more data processing systems and/or clients.

Network 1575 may be the Internet, a virtual private network, a local area network, a wide area network, a broadband digital network or any other appropriate structure for enabling communication between two or more nodes or locations. Network 1575 may include a shared, public, or private data network and encompass a wide area or local area. Network 1575 may include one or more wired and/or wireless connections. Network 1575 may employ communication protocols such as User Datagram Protocol (UDP), Transmission Control and Internet Protocol (TCP/IP), Asynchronous Transfer Mode (ATM), SONET, Ethernet, or any other compilation of procedures for controlling communications among network locations. Further, in certain embodiments, network 1575 may leverage voice-over Internet Protocol (“VoIP”) technology.

Various components within environment 1500 may be operatively connected to network 1575 by communication devices and software known in the art, such as those commonly employed by Internet Service Providers (ISPs) or as part of an Internet gateway. Components operatively connected to network 1575 may be assigned network identifiers (ID). As used herein, the term “ID” refers to any symbol, value, tag, or identifier used for addressing, identifying, relating, or referencing a particular element. Network IDs, for example, may include IP addresses.

Client 1550 may represent one or more devices used by one or more users to access network 1575. In one configuration, client 1550 may be similar in structure and functionality to data processing system 1510. Client 1550 may, however, be structurally and/or functionally different from data processing system 1510. In one configuration, client 1550 may include a general-purpose computer, a personal computer (e.g., a desktop), or a workstation. Client 1550 may also include mobile computing devices (e.g., laptops, PDAs, a Blackberry™, an Ergo Audrey™, etc.), mobile communications devices (e.g., cell phones), or other structures that enable users to remotely access information. In certain configurations, client 1550 could include kiosks or “dumb” terminals coupled to one or more central data processing systems. Consistent with aspects of the invention, client 1550 and server 1510 may communicate using known protocols, such as a TCP/IP protocol stack utilizing a web server coupled to network 1575 and a web browser. Those skilled in the art will realize that a plurality of geographically-dispersed clients, each different in structure and capability, may be included in environment 1500. One exemplary configuration of a client 1550 is detailed below in connection with FIG. 16.

FIG. 16 illustrates one exemplary configuration 1600 of environment 1500, consistent with the present invention. As illustrated in FIG. 16, data processing system 1510 (e.g., a server) may comprise a network interface 1612, storage 1614, a processor 1616, and a data port 1618. A system bus (not illustrated) may interconnect these components. Such a system bus may be a bidirectional system bus. For example, it could contain separate address lines and data lines. Alternatively, the data and address lines may be multiplexed. Data processing system 1510 may comprise additional and/or fewer components, and one or more of the components implemented in data processing system 1510 may be scalable in order to accommodate additional services, data, and/or users.

Network interface 1612 may be any appropriate mechanism and/or module for facilitating communication with a network. Network interface 1612 may leverage hardware, software, and/or firmware elements. Network interface 1612 may be configured for sending information to and receiving information from network 1575, or any other network such as an attached Ethernet LAN, serial line, etc. Network interface 1612 may include executable program code for facilitating information exchange with attached networks. Network interface 1612 may include or leverage one or more network cards and/or data and communication ports.

Storage 1614 may provide mass storage and/or cache memory for data processing system 1510. In addition, storage 1614 may include elements for providing a primary memory for processor 1616, such as for program code. Storage 1614 may be implemented with a variety of components or subsystems including, for example, a hard drive, an optical drive, CD ROM drive, DVD drive, a general-purpose storage device, a removable storage device, and/or other devices capable of storing information. Storage 1614 may include a random access memory, a read-only memory, magnetic and optical storage elements, organic storage elements, audio disks, and video disks. Although storage 1614 is shown within data processing system 1510, storage 1614 may be implemented external to data processing system 1510. Further, although a single storage module is shown, any number of modules may be included in data processing system 1510, each configurable for performing distinct functions.

Storage 1614 may include program code for various applications, an operating system, an application-programming interface, application routines, and/or other executable instructions. Storage 1614 may also include program code and information for communications (e.g., TCP/IP communications), kernel and device drivers, and configuration information.

As illustrated in FIG. 16, elements of PPM system 1000 may be implemented in storage 1614. That is, storage 1614 may include a software layer that includes executable program code for performing one or more functions of PPM system 1000. Each of PPM system modules 1015, 1020, 1040, and 1050 may be embodied by a software module embedded within such a software layer in storage 1614. In certain configurations, the software layer may include or leverage a hardware interface component. Such a hardware interface component may include boot executable software and/or driver software.

Processor 1616 may be operatively configured to execute instructions. Processor 1616 may be configured for routing information among components and devices and for executing instructions from one or more memories. Although FIG. 16 illustrates a single processor, data processing system 1510 may include a plurality of general-purpose processors and/or special purpose processors (e.g., ASICS). Processor 1616 may also include, for example, one or more of the following: a co-processor, a memory, registers, and other processing devices and systems as appropriate. Processor 1616 may be implemented, for example, using a Pentium™ processor provided from Intel Corporation.

When data processing system 1510 executes applications and/or instructions installed in storage 1614, processor 1616 may download at least a portion of program code from storage 1614 into a primary processor memory (not shown). As processor 1616 executes the program code, processor 1616 may also retrieve additional portions of program code from storage 1614.

Data port 1618 may represent one or more ports for operatively connecting to one or more external systems, such business process source systems located external to data processing system 1510. (Skilled artisans will appreciate that certain source systems could be implemented by data processing system 1510). In one configuration, data port 1618 may transmit and receive data serially or in parallel. In certain embodiments, data port 1618 may interact with source systems and/or PPM system 1000 (e.g. source interface module 1015) in order to obtain information from business process source systems.

In one configuration, client 1550 may include components similar to those included in data processing system 1510, such as network interface 1612 and processor 1616. Client 1550 may, however, be structurally different from data processing system 1510 and may have varying or additional components. As illustrated in FIG. 16, client 1550 may comprise a network interface 1612, a processor 1616, I/O devices 1622, a display 1624, and a storage 1626. A system bus (not illustrated) may interconnect such components, as discussed above in connection with data processing system 1610.

Client 1550 may receive input via one or more input/output (I/O) devices 1622. I/O devices 1622 may include components such as keyboard, a mouse, a pointing device, and/or a touch screen or information-capture devices, such as audio- or video-capture devices. I/O devices 1622 may include one or more data reading devices and/or input ports.

Client 1550 may present information and interfaces (e.g., GUIs) via display 1624. Display 1624 may be configured to display text, images, or any other type of information. In certain configurations, display 1624 may display information by way of a cathode ray tube, liquid crystal, light-emitting diode, gas plasma, or other type of display mechanism. Display 1624 may additionally or alternatively be configured to audibly present information. Display 1624 may be used in conjunction with I/O devices 1622 for facilitating user interaction with client 1550.

Storage 1626 may provide mass storage and/or cache memory for client 1550. Storage 1626 may include program code for various client applications. For example, one or more applications that enable users to interact with PPM system 1000 may be implemented in storage 1626. Storage 1626 may be implemented with a variety of components or subsystems. Storage 1626 may be of similar structure and function to storage 1614 in data processing system 1510. In certain configurations, however, storage 1626 may have less storage capacity than storage 1614 in order to reduce cost and size. In certain configurations, storage 1626 may include or leverage one or more programmable, erasable and/or re-useable storage components, such as EPROM (erasable programmable read-only memory) and EEPROM (erasable programmable read-only memory). Storage 1626 may also include or leverage constantly-powered nonvolatile memory operable to be erased and programmed in blocks, such as flash memory (i.e., flash RAM). Although storage 1626 is shown within client 1550, elements of storage 1626 may be implemented external to client 1550. Further, although a single storage module is shown, any number of modules may be included in client 1550, and each may be configured for performing distinct functions.

For purposes of explanation only, certain aspects of the present invention are described herein with reference to the discrete functional elements illustrated in FIGS. 15 and 16. The functionality of the elements and modules illustrated in FIGS. 15 and 16 may, however, overlap and/or may be present in a fewer or greater number of elements and modules. Elements of each system may, depending on the implementation, lack certain illustrated components and/or contain, or be coupled to, additional or varying components not shown. Further, all or part of the functionality of the illustrated elements may co-exist or be distributed among several geographically dispersed locations. Moreover, embodiments, features, aspects and principles of the present invention may be implemented in various environments and are not limited to the illustrated environments and architectures. In addition, the processes disclosed herein are not inherently related to any particular apparatus or system and may be implemented by any suitable combination of components.

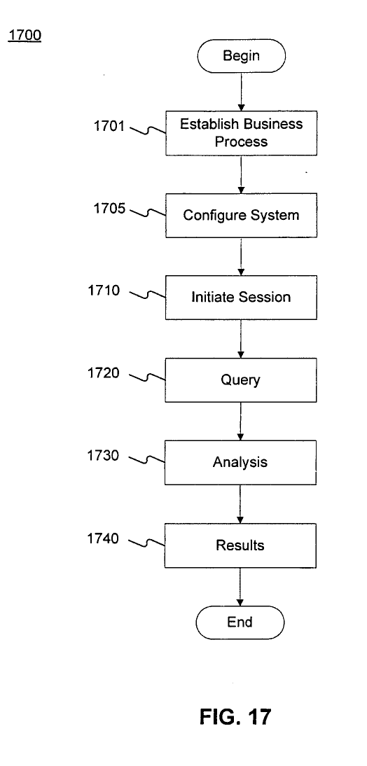

FIG. 17 is a flowchart depicting an exemplary business process analysis method 1700, consistent with principles and aspects of the present invention. Method 1700 may begin when a business process is established (step 1701). For example, one or more business entities may develop and implement a business process. Method 1700 may also include system configuration (step 1705). System configuration may involve implementing PPM system 1000 and specifying various parameters and settings. In one example, system configuration may include specifying process fragment definitions, implementing a particular convention (e.g., EPC), setting attributes, specifying merge rules, specifying mappings, and configuring performance indicators and dimensions, each of which may be stored in repository 1040. System configuration may also include programming or configuring one or more source systems and client devices, and establishing communication links between PPM system 1000, source systems, and client devices.

As illustrated in FIG. 17, a user may initiate a session (step 1710) with a client device (e.g., client 1550). In at least one example, a user may initiate a session with a client device via a front end or user interface (e.g., user interface module 1050). Initiating a session may, in certain embodiments, involve user authentication and validation. Prior to gaining access to PPM system 1000 (which may reside in data processing system 1510), a user may login to the system via client device 1550 (e.g., by inputting credentials to client 1550). Credentials may include usernames, passwords, etc. In certain implementations, the user-entered credentials may be routed from the respective client to PPM system 1000 in data processing system 1510. User interface 1050 may perform user validation and authentication functions using the entered credentials. In certain configurations, a public key infrastructure (PKI) employing public key cryptography may be leveraged to perform user authentication processes.

Once a user gains access to PPM system 1000, the user may initiate a query (step 1720). For example, a user may enter a command or selection to client device 1510 (via user interface 1050) that initiates one or more actions by PPM system 1000. The command or selection may select a particular business process to analyze, request one or more information views, and/or initiate one or more business process analyses. In one example, the command or selection might also specify one or more dimensions and performance indicators to be calculated by PPM system 1000. The command or selection may be transmitted over network 1575 to data processing system 1510 and may initiate performance of the desired action by PPM system 1000.

As explained above, various views and levels of access may be provided to users by user interface 1050. Accordingly, although not shown in FIG. 17, method 1700 may involve performing user authentication and validation in order to provide users with appropriate views. For example, when a user requests a specific view or analyses, the user may enter (e.g., in response to a prompt) credentials contemporaneously with the request or subsequent to the request (e.g., immediately after the request). Users may also be prompted to enter credentials at predetermined time intervals.

Once a user initiates a query and that query is received by PPM system 1000, the desired action (e.g., analysis) may be performed by PPM system 1000 (step 1730). For example, PPM system 1000 may perform one or more performance indicator calculations. PPM system 1000 may perform such calculations using information obtained from one or more source systems, information stored in repository 1040 (e.g., stored process fragments, fragment definition, merge rules, mappings, attributes, performance indicator formulas, etc.), and/or information received from the user (e.g., specific dimensions).

After performing the desired analysis, PPM system 1000 may present the results of that analysis to the user (step 1740). In one example, user interface 1050 may present a graphical representation of the analysis results to the user via display device 1624 of client 1550. In certain embodiments, users may retrieve or view results by selecting criteria, such as at least one performance indicator in combination with various dimensions. PPM system 1000 may provide analysis results in response to the selected criteria. Upon viewing the analysis results, the user may drill-down to more specific details (e.g., transactions, etc.) and/or obtain broader views of business process performance by viewing analysis results on an aggregated basis.

FIG. 17 is consistent with exemplary implementations of the present invention. The sequence of events described in FIG. 17 is exemplary and not intended to be limiting. Other steps may therefore be used, and even with the method depicted in FIG. 17, the particular order of events may vary without departing from the scope of the present invention. Moreover, certain steps may not be present and additional steps may be implemented in the method illustrated in FIG. 17. In addition, it should be understood that the stages of FIG. 17 may be modified with departing from the scope of the present invention.

The foregoing description of possible implementations consistent with the present invention does not represent a comprehensive list of all such implementations or all variations of the implementations described. The description of only some implementations should not be construed as an intent to exclude other implementations. Artisans will understand how to implement the invention in the appended claims in may other ways, using equivalents and alternatives that do not depart from the scope of the following claims. Moreover, unless indicated to the contrary in the preceding description, none of the components described in the implementations is essential to the invention.

1. A method for acquiring time-dependent data to perform business process analysis, the method comprising:
importing time-dependent data from a plurality of source systems using a generic import interface;
defining process fragments from the imported time-dependent data and merging the process fragments to generate process instances;
merging the process instances into a process model, the process model being representative of a business process; and
calculating performance indicators to analyze the business process based on the process model and time-dependent data imported from the plurality of source systems.

2. The method of claim 1, wherein importing time-dependent data from a plurality of source systems comprises obtaining information from at least one of workflow software, a customer relationship management system, an enterprise resource management system, an enterprise application integration system, a computer integrated manufacturing system, and a supply chain management system.

3. The method of claim 1, wherein importing time-dependent data using a generic import interface comprises importing time-dependent data from a plurality of source systems without using adapters for the source systems.

4. The method of claim 1, wherein importing time-dependent data comprises extracting at least one data record as a representation of an executed business process activity.

5. The method of claim 1, further comprising generating a log containing information related to the performance of business process activities.

6. The method of claim 1, wherein importing time-dependent data comprises identifying potential source system events and logging occurrences of the identified source system events.

7. The method of claim 6, wherein identifying potential source system events comprises identifying potential status changes in the plurality of source systems.

8. The method of claim 1, wherein importing time-dependent data comprises receiving at least one source system event from the plurality of source systems.

9. The method of claim 1, wherein defining process fragments from the imported time-dependent data and merging the process fragments to generate process instances comprises:
merging the process fragments based on identifiers associated with process fragments.

10. The method of claim 1, wherein defining process fragments from the imported time-dependent data and merging the process fragments to generate process instances comprises:
merging the process fragments based on events included in the process fragments.

11. The method of claim 1, wherein defining process fragments from the imported time-dependent data and merging the process fragments to generate process instances comprises:
identifying at least two process fragments having corresponding events and consolidating the corresponding events into a single event.

12. The method of claim 1, wherein defining process fragments from the imported time-dependent data and merging the process fragments to generate process instances comprises:
assigning source system event types to process fragment definitions.

13. The method of claim 1, wherein defining process fragments from the imported time-dependent data and merging the process fragments to generate process instances comprises:
merging the process fragments to generate representations of particular process realizations.

14. The method of claim 1, wherein calculating performance indicators comprises calculating at least one performance indicator for each of the process instances.

15. A method for acquiring time-dependent data to perform business process analysis, the method comprising:
obtaining information representing at least one source system event from at least one source system associated with a business process;
generating a first process fragment in response to the obtained information;
merging the first process fragment with at least a second process fragment to generate a first instance of the business process;
merging the first instance of the business process with at least a second instance of the business process to generate a first representation of the business process; and
analyzing the business process based on the first representation of the business process.

16. The method of claim 15, wherein obtaining information representing at least one source system event comprises obtaining information representing at least one source system status change.

17. The method of claim 15, wherein generating a first process fragment in response to the obtained information comprises searching for the at least one source system event in fragment definitions listing.

18. The method of claim 15, wherein generating a first process fragment comprises assigning the at least one source system event to a defined process fragment using a mapping.

19. The method of claim 15, wherein generating a first process fragment comprises generating the first process fragment based on process fragment definitions and a process fragment mapping, the process fragment mapping specifying assignments of source system event types to process fragment definitions.

20. The method of claim 15, wherein merging the first process fragment with at least a second process fragment comprises identifying common events in the first process fragment and the second process fragment.

21. The method of claim 20, wherein merging the first process fragment with at least a second process fragment comprises consolidating the common events into a single event within the first instance of the business process.

22. The method of claim 15, wherein analyzing the business process based on the representation of the business process comprises calculating at least one performance indicator for the first instance and the second instance of the business process.

23. The method of claim 22, wherein calculating at least one performance indicator for the first instance and the second instance comprises calculating the at least one performance indicator based on at least one dimension.

24. The method of claim 15, wherein analyzing the business process comprises allowing a user to view details of the first instance and the second instance and allowing the user to view the first instance and the second instance on an aggregated basis.

25. The method of claim 15, wherein analyzing the business process comprises aggregating the first representation of the business process with at least a second representation of the business process.

26. The method of claim 15, wherein analyzing the business process comprises performing a multi-dimensional analyses of the business process.

27. The method of claim 15, wherein analyzing the business process comprises performing at least one trend analysis over at least one period of time.

28. The method of claim 15, wherein analyzing the business process comprises analyzing the business process in accordance with user input.

29. The method of claim 15, wherein analyzing the business process comprises provided at least one view of analysis information to at least one user to facilitate management of the business process.

30. A system for acquiring time-dependent data to perform business process analysis, comprising:
a data processing device including:
a first port for transmitting and receiving data; a memory comprising executable instructions for:
interfacing with the at least one source system via the first port to obtain from the at least one source system runtime data associated with a running business process;
generating a first process fragment in response to the obtained information and merging the first process fragment with at least a second process fragment to generate a first instance of the business process;
merging the first instance of the business process with at least a second instance of the business process to generate a first representation of the business process; and
analyzing the business process based on the first representation of the business process;
a processor for executing the instructions; and
a second port for receiving a command from a client device to analyze the business process.

31. The system of claim 30, wherein the data processing device is a server.

32. The system of claim 30, further comprising a network-based database for storing the first and second process fragments, the first and second instances of the business process, the first representation of the business process, and analysis results.

33. The system of claim 30, wherein the source system comprises a workflow system.

34. The system of claim 30, wherein the source system comprises at least one of a customer relationship management system, an enterprise resource management system, an enterprise application integration system, a computer integrated manufacturing system, and a supply chain management system.

35. The system of claim 30, wherein the source system implements the business process.

36. The system of claim 30, wherein the memory comprises instructions for generating a file that contains data representing at least one source system event based on the information received by the first port.

37. The system of claim 30, wherein the instructions for generating a first process fragment comprise instructions for generating the first process fragment based on process fragment definitions and a process fragment mapping, the process fragment mapping specifying assignments of source system event types to process fragment definitions.

38. The system of claim 30, wherein the instructions for merging the first process fragment with at least a second process fragment comprise instructions for identifying common events in the first process fragment and the second process fragment.

39. The system of claim 38, wherein the instructions for merging the first process fragment with at least a second process fragment comprise instructions for consolidating the common events into a single event within the first instance of the business process.

40. The system of claim 30, wherein the instructions for analyzing the business process based on the representation of the business process comprise instructions for calculating at least one performance indicator for the first instance and the second instance of the business process.

41. The system of claim 30, wherein the instructions for analyzing the business process comprise instructions for aggregating the first representation of the business process with at least a second representation of the business process.

42. The system of claim 30, wherein the instructions for analyzing comprise instructions for transmitting analysis results over the network to the client via the second port.

43. The system of claim 30, wherein the instructions for analyzing comprise instructions for providing the client with a representation of the business process.

44. An import apparatus comprising:
interfacing means for obtaining information representing at least one source system event from at least one source system associated with a business process;
fragment generating means for generating a first process fragment in response to the obtained information;
fragment merging means for merging the first process fragment with at least a second process fragment to generate a first instance of the business process;
instance merging means for merging the first instance of the business process with at least a second instance of the business process to generate a first representation of the business process; and
analyzing means for analyzing the business process based on the first representation of the business process.

45. A method for acquiring time-dependent data to perform business process analysis, the method comprising:
obtaining information from a plurality of source systems associated with a business process using an import interface;
generating a representation of the business process using the obtained information; and
analyzing the business process based on the representation of the business process.

46. The method of claim 45, wherein obtaining information comprises obtaining graph-formatted information from at least one of the source systems.

47. The method of claim 46, wherein obtaining graph-formatted information includes obtaining information representing source system events and procedural logic associated with the source system events.

48. The method of claim 46, wherein obtaining graph-formatted information includes obtaining process fragments.

49. The method of claim 48, wherein generating a representation of the business process comprises:
merging the process fragments to generate instances of the business process; and
merging the instances of the business process to generate the representation of the business process.

50. The method of claim 46, wherein obtaining graph-formatted information includes obtaining process instances.

51. The method of claim 50, wherein generating a representation of the business process comprises merging the instances of the business process to generate the representation of the business process.

52. The method of claim 45, wherein obtaining information comprises obtaining source system events from the source system.

53. The method of claim 52, wherein obtaining source system events comprises obtaining changes in status of a source system resulting from an executed activity associated with the business process.

54. The method of claim 52, wherein generating a representation of the business process using the obtained information comprises:
generating process fragments in response to the obtained information;
merging the process fragments to generate instances of the business process; and
merging the process instances into a process model, the process model being representative of the business process.

55. A system for acquiring time-dependent data to perform business process analysis, comprising:
first obtaining means for obtaining information in a first format from a first source system associated with a business process;
second obtaining means for obtaining information in a second format from a second source system associated with the business process;
representing means for generating a representation of the business process using the information obtained in the first and second formats; and
analyzing means for analyzing the business process based on the representation of the business process.

56. The system of claim 55, wherein the first obtaining means obtains information representing first business process fragments and the second obtaining means obtains information representing source system events.

57. The system of claim 56, wherein the representing means comprises:
means for generating second business process fragments in response to the information obtained from the second obtaining means;
means for merging the first process fragments and the second process fragments to generate instances of the business process; and
means for merging the process instances to generate a process model, the process model being representative of the business process.

58. The system of claim 55, wherein the first obtaining means obtains information representing first business process instances and the second obtaining means obtains information representing source system events.

59. The system of claim 58, wherein the representing means comprises:
means for generating business process fragments in response to the information obtained from the second obtaining means;
means for merging the process fragments to generate second instances of the business process; and
means for merging the first process instances and the second process instances to generate a process model, the process model being representative of the business process.

60. A computer-readable medium containing instructions for controlling a computer system to perform a method, the computer system having a processor for executing the instructions, the method comprising:
importing time-dependent data from a plurality of source systems using a generic import interface;
defining process fragments from the imported time-dependent data and merging the process fragments to generate process instances;
merging the process instances into a process model, the process model being representative of a business process; and
calculating performance indicators to analyze the business process based on the process model and time-dependent data imported from the plurality of source systems.
